(19) United States
(12) Patent Application Publication
(10) Pub. No.: US 2010/0299177 A1
(43) Pub. Date: Nov. 25, 2010

(54) DYNAMIC BUS DISPATCHING AND LABOR ASSIGNMENT SYSTEM

(75) Inventors: Peter S. Buczkowski, Windermere, FL (US); Douglas C. Lord, Winter Garden, FL (US); Frank J. Tortorici, JR., Gotha, FL (US); Kurt G. Kaufmann, Orlando, FL (US); Jose A. Mola, Orlando, FL (US); Gary N. Simmons, Mount Dora, FL (US); Kathleen A. Kilmer, Winter Garden, FL (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., Burbank, CA (US)

(21) Appl. No.: 12/470,750

(22) Filed: May 22, 2009

(51) Int. Cl. G06Q 10/00

(52) U.S. Cl. 705/9; 705/7

(57) ABSTRACT

A method of dynamic bus dispatching and labor assignments based on real time vehicle and passenger data. The method includes running a transportation services module on a computer of a dispatch command center. The method includes receiving, at the computer system, current location information for a plurality of buses. The transportation services module determines a route completion time period for the vehicles and then generates a dispatch schedule for each of the vehicles based on the determined route completions. The dispatch schedules are transmitted to the buses and displayed on a monitor to the bus driver, thereby allowing real time or dynamic updating of dispatching based on collected location information. The method also includes determining and reporting a set of labor assignments for drivers of the buses based on the current location information, the route completion time periods, and break and shift information associated with each of the drivers.

### CROSS-REFERENCE TO RELATED APPLICATIONS

This application is related to co-pending U.S. patent application Ser. No. 12/356,669 filed Jan. 21, 2009, which is incorporated herein by reference in its entirety.

### BACKGROUND OF THE INVENTION

1. Field of the Invention

The present invention relates, in general, to methods and systems for planning deployment or dispatching of buses/vehicles and drivers based on such ridership predictions, and, more particularly, to systems and methods for dynamic bus dispatching and labor assignments to react to changes in demand, traffic patterns, and business conditions on an ongoing and real time basis.

2. Relevant Background

In many locations, there is a growing demand for transportation, such as buses and other multi-passenger vehicles, to carry passengers or riders from numerous origins to a variety of destinations. Public transportation has long provided buses that travel along predefined routes and pick up and drop off passengers along the route. These routes typically are consistent for weekdays and have a different schedule for weekends to accommodate city demands. Private transportation systems are often used to transfer riders from one location to another such as from a parking lot, a hotel/resort, or a business to another business or destination such as a sporting arena, a ski hill, an amusement park, and so on. Cab companies operate dispatch centers to route their cabs accounting for driver changes and increases in demand in various locations. Airports often have shuttle vans to accommodate airline passengers staying at city-center hotels that do not rent a personal vehicle. Delivery trucks and similar vehicles often follow a number of predefined routes to transport goods from one location, such as a depot, and to another location, such as a retailer or recipient location for the goods.

A common goal for transportation providers is to meet the varying demand for buses and other vehicles. A conflicting goal, though, is to control costs including meeting demand without over-servicing a route. For example, running buses on routes at low capacity is not cost efficient, and it is desirable to run enough buses to service ridership demand while keeping ridership at a particular level. Planning bus routes, dispatching buses, and providing enough drivers can be complicated due to these and other operating considerations.

For example, it may be a goal of the transportation provider to make getting to and from an amusement park or other destination part of the overall experience or, in other words, to be hassle free and enjoyable. This may be a difficult task, though, if that transportation provider has to service numerous pick up locations or origins and also service a variety of drop off locations or destinations. One example may be an amusement park complex made up of a number of entertainment facilities (“destinations”) as well as numerous origins for park guests such as parking lots, hotels/resorts, and other entertainment facilities. Of course, the labels are often reverse with origins becoming destinations when the busses are traveling the other direction (e.g., returning guests to their vehicles or hotels). Bus operations may involve dispatching hundreds of buses in such an operation and assigning hundreds to a thousand or more drivers to drive these buses during all operating hours for the complex. In one setting, statistics have shown that over one hundred thousand riders are serviced everyday by the amusement park complex buses.

Existing transportation systems typically are reactive rather than proactive. Specifically, public transportation is typically provided along routes that are set based on polls of the local population and predictions of where needs may exist, such as to and from a business district of a city. The routes and number of buses may be periodically changed based on a reaction to complaints of the riders, based on driver input as to demand, or based on physical counts of riders on a route (e.g., count number of passengers boarding each bus). In the resort or amusement complex example, routes and need for buses/drivers is typically planned by manually estimating the resort population (i.e., number of guests staying at the resort) and expected visitors (e.g., for parking lots and exits), estimating times these guests may travel on various routes, estimating demand for various routes, and then assigning a fitting number of buses to each of these routes. In some cases, the number of buses and routes is adjusted based on driver and user feedback, but, at this point, the feedback is typically a complaint about the lack of service or an unenjoyable experience involving waiting long periods for a bus. Guest service is typically much more important in the amusement park scenario than for city transit, since guest satisfaction is directly related to the intent of the guest to return to the park.

Hence, there remains a need for improved methods and systems for better determining actual demand for bus or other transportation services. Preferably, such a method and system would provide results that would facilitate better prediction of future demands for transportation services that can be used to plan routes, frequency of buses/vehicles on routes, number of vehicles for a particular day, drivers/operators, and other dispatching parameters.

### SUMMARY OF THE INVENTION

The present invention addresses the above problems by providing methods and systems for forecasting future ridership and demand for bus and other transportation services based upon actual measured or counted use. Briefly, automatic passenger counters combined with vehicle locators are used to provide count data for use of a route with a number of stops. At the stops, passengers are counted as they board (oncounts) and debark/leave (offcounts) at each stop. The route may be divided into a number of origin-destination pairs (e.g., a stop where passengers embark is paired with a stop where passengers debark). The count data is gathered over a period of days, weeks, and months, and this historical data or passenger count for the route is then attributed to the route as demand or passenger use of the route, and, more typically, the demand is associated with each OD pair at the specific time of the entry/exit event. The historical OD pair-demand data may then be processed by forecasting and planning software to better forecast future demand. For example, a ridership forecasting tool may use the OD pair-demand data to forecast future demand for buses on the route, and labor and dispatching tools may use this demand (or demand that is further granularized to be associated with each OD pair per time period such as every 15 minutes) to optimize bus routes/schedules and labor assignments that best fit the guest demand profile.

More particularly, a method is provided for performing dynamic bus (or other passenger-transport vehicle) dispatching and creation of labor assignments based on real time collected and processed data. The method includes running a transportation services module (such as a deployment tool, intraday labor planner, a labor and dispatch planning module, or the like) on a computer system or within a dispatch command center. The method continues with receiving, at the computer system or command center, current location information for a plurality of buses. The transportation services module is then used to determine a route completion time period for each of the vehicles and then to generate a dispatch schedule for each of the vehicles based on the determined route completions. Each of these dynamically generated dispatch schedules may be transmitted to the buses and displayed on a monitor to the bus driver, thereby allowing real time or dynamic updating of dispatching based on collected location information. Alternatively, these dispatches may be communicated via radio or given by human dispatch coordinators, e.g., there may be cases where the transportation services module presents the dispatch schedule or other output data to a human such as a dispatcher that then determines whether to transmit the output data or a portion of such data and in what form or which communication media.

The generating of the dispatch schedule may also include determining demand for the routes serviced by the buses based on counts of the passengers, and the dispatch schedule may be modified based on the determined demand. The dispatch schedule generating may also include determining service intervals for the routes based on the received location information, and the dispatch schedule may be generated or modified based on the determined service intervals and a set of predefined goal service intervals (e.g., ideal guest service intervals or the like) for the routes, which may be retrieved from memory accessible by the computer system. The dispatch schedule may also be based on individual service needs that are entered into the system (such as a cab service implementation or the like). The demand and service intervals may be determined for a plurality of OD pairs defined for the routes. The model/method may also involve determining which OD pairs should be combined based on the goal of minimizing or reducing cost, and, in a cab service implementation, the model/method may include recommending when to combine passenger demand or requests based on geography. The dispatch schedule generating may also include assigning penalties and/or bonuses to some of the buses based on a comparison of the determined or current service intervals and the goal service intervals for the routes (and then the penalties and/or bonuses may be used in creating a new dispatch schedule to minimize/decrease future penalties and/or to maximize/increase bonuses). The method may also include determining and reporting a set of labor assignments for drivers of the buses based on the current location information, the route completion time periods, and break and shift information associated with each of the drivers. The generating of the dispatch schedule typically may also include constructing a network flow model for a geographic service area for the buses and then solving the network flow model to provide demand and service information for use by the transportation services module in creating the dispatch schedule for the buses.

### BRIEF DESCRIPTION OF THE DRAWINGS

FIG. 1 is a functional block diagram of a transportation system with a fleet of vehicles (e.g., buses or the like) adapted to transmit location and passenger count data (e.g., APC data) to a ridership prediction and dispatching system for use in associated measured demand with origin-destination (OD) pairs for a number of vehicle routes;

FIG. 2 illustrates schematically a geographical area serviced by a transportation system (such as the system of FIG. 1) illustrating OD pairs for an exemplary simplified route;

FIG. 3 illustrates exemplary input data or automatic passenger count (APC) data received from vehicles and stored in memory of a ridership prediction and dispatching system;

FIG. 4 illustrates exemplary output data of a ridership prediction and dispatching system such as from a passenger count to OD pair translation module or similar software tool used to determine demand and allocate it to OD pairs per time period;

FIG. 5 is a functional block diagram of a guest/rider transportation planning and deployment system of an embodiment showing use of APC data and other information from a bus fleet to produce OD-demand data that is processed by a guest demand forecast mechanism to produce demand profiles for a route (and for OD pairs of that route) for each time interval of a day; and

FIG. 6 illustrates a process for associating ridership information (e.g., APC data) with OD pairs such as may be implemented by operation of the systems of FIGS. 1 and 5;

FIG. 7 illustrates a process for further processing ridership or APC data from a fleet of vehicles to provide accurate OD pair-demand data including determining when passengers or riders arrived at pick up locations or origins, to the nearest 15-minute time interval;

FIG. 8 illustrates a dispatching determination process of an embodiment of the invention as may be performed by the transportation system of FIG. 1 and/or by the guest/rider transportation planning and deployment system of FIG. 5;

FIG. 9 illustrates in more detail the preprocessing for the network flow model that may be performed as part of the process or method of FIG. 8;

FIG. 10 illustrates a graph showing network flow alternatives in a matrix as a function of ideal guest service interval;

FIGS. 11 and 12 illustrate graphs of sample penalty functions that may be used in the network flow modeling described herein;

FIG. 13 illustrates in more detail process of constructing a network flow model that may be performed as part of the process or method of FIG. 8; and

FIGS. 14 and 15 are graphs showing demand/service windows for group dispatching targeted wait times.

### DETAILED DESCRIPTION OF THE PREFERRED EMBODIMENTS

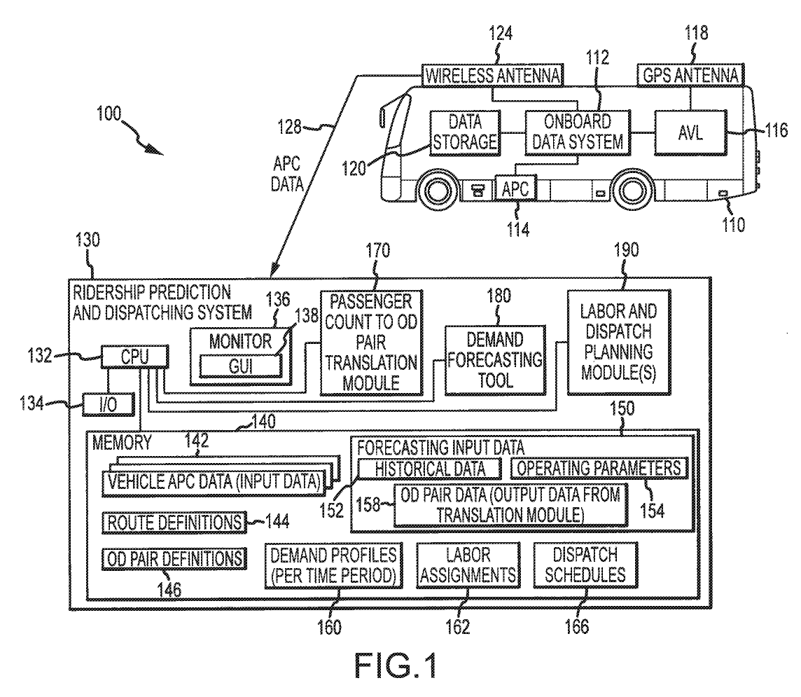

Briefly, embodiments of the present invention are directed to methods and systems for better predicting or forecasting demand for vehicles such as buses within a transportation system, e.g., a resort complex where guests are transported from lodging to entertainment facilities/locations, a regional transportation district providing bussing to its citizens, a van service from airports, and so on. More effective passenger service may be provided bases on ridership/demand and operating hours both which may change on a daily basis. To this end, embodiments of the present invention also are directed to generating a customized dispatch schedule to insure guest or rider service is maintained at predetermined or assignable levels while not over-servicing a bus or other rider transportation vehicle route. To meet the customized schedule at minimum or acceptable costs, a dynamic dispatching system (and corresponding methods) is provided that adapts to real-time changes in demand (and other parameters) and routes buses more efficiently (e.g., optimized to a particular model). The dispatching system grabs or obtains real-time information about the current state of all buses and drivers (service providers) and then feeds the information to two dispatch optimization models/tools that act to determine a more (or even most) efficient way to meet the schedule (e.g., with a revised dispatch schedule for buses or other vehicles and/or updated labor schedule/assignments). The following description begins with a discussion of methods for forecasting demand and explanation of use of origin-destination pairs for forecasting ridership (e.g., with reference to FIGS. 1-7). The description then continues on with discussion of use of the same transportation systems (or other system embodiments) to implement dynamic bus dispatching and labor assignment methods of embodiments of the invention.

The following description highlights the use of counts of passengers boarding and leaving a vehicle, such as a bus, at various stops to determine in a more accurate manner the historical demand for transportation on a set of bus routes. The demand is determined in part by assigning riders or passengers to particular routes in a more granular manner such as by dividing a route into a set of origin-destination (OD) pairs and then assigning the measure rider counts to particular OD pairs. Further, the demand is determined over time such that the demand data includes rider counts for OD pairs for particular time intervals on a daily basis (e.g., demand may be a number of passengers that used a bus on a particular route to travel from a particular origin or stop to another stop or destination (an identified OD pair) on a particular day in the interval of 8 AM to 8:30 AM or some other time period). The OD pair demand data may be fed to one or more planning tools such as a guest or rider forecast tool that may combine this data with other operating parameters to generate significantly improved demand profiles for a bus fleet and its operators/drivers. Further, the demand profiles may then be used to create labor assignments/schedules and routing information (e.g., number of buses serving a route or even OD pair of a route, driver schedules, scheduling of bus dispatches to locations, and the like).

The inventors recognize that service standards, such as short waiting periods for a next bus, can better be maintained or achieved when guest or passenger demand is more accurately estimated. However, it is also understood that determining how to route buses, how many buses to provide on each route, and how often to dispatch buses on each route is a very difficult task, especially when performed without accurate ridership data or generalized passenger counts. For example, a transportation system may be made up of ten to hundred buses or more with one exemplary transportation system studied by the inventors including nearly 300 buses that carry a ridership of approximately 150,000 daily guest or passenger trips. In the resort/entertainment complex setting, the operating hours and resort population changes every day, which requires customized dispatch schedules based on these changing operating conditions. Similarly, public transportation systems see variations that vary with each day of the week and vary during the day. To address these challenges, the process described herein outfits each bus with automatic passenger/people counters (APCs) to determine when passengers board and leave a bus and automated vehicle locators (AVLs) to determine via global satellite positioning (GPS) the location of the bus at particular times. The APC and AVL information (sometimes shortened to APC data in the description) provides records of actual ridership for each bus of a fleet, and the measured ridership data is utilized to predict future ridership.

Before providing specific examples, it may be useful to provide a high level overview of the use of actual ridership data to predict future demands for a vehicle fleet. An exemplary ridership prediction and dispatching system may include on-board APCs and GPS location devices on each bus to provide APC data, and, significantly, tie the measured bus ridership to GPS-provided locations at a specific time. A conversion or translation algorithm may be used to convert raw ridership to demand by OD pair by a time period (e.g., demand for an OD pair for N minutes such as 15 minute periods, 30 minute periods, and the like). Typically, routes may have multiple origins and destinations (e.g., multiple OD pairs within a single bus or transportation route as passengers board at multiple stops and/or debark at more than one stop/location), and multiple OD pairs per route makes conversion of raw data to OD pair demand data difficult and complicated. Most routes have either multiple origins or multiple destinations, and, occasionally, destinations are served in the succeeding route.

In some embodiments, two conversions are performed for the raw data conversion or translation. First, a determination is made of how many guests/passengers alighted at each stop for each specific destination. This determination is followed by determining the appropriate time bucket or period for the raw ridership data (e.g., corresponding 15-minute time bucket), such as by determining the last time the OD pair associated with the data was serviced by a bus. The time bucket determination may also involve projecting the guest/passenger arrival rate since the last service time. This determination considers the number of passengers that got on at that particular stop and the percentage of passengers that depart at each destination. Hence, the ridership prediction method taught captures actual ridership and attributes this raw ridership in an accurate manner to OD pairs of a number of routes to provide demand per OD pair for each time period of a day (e.g., ridership/passenger count for each 15 minute period of a day for a bus traveling between an OD pair on a particular route).

The method may further include providing the OD pair demand data as input to a sophisticated forecasting technique to generate a guest demand forecast for one or more upcoming days. The forecasting module/software may process a single day's OD pair data but more typically will include data from at least a few days and more typically months of historical OD pair demand data to improve the accuracy of the forecasts of passenger demand for transportation services. No other transit system tracks guest/passenger counts to individual OD pairs and specific time periods. It is expected that such ridership data may prove to be a major asset to municipalities, van/cab services, and resort (or other entertainment complex) operators because they could track demand and customize their schedules (bus dispatches, driver work assignments, and the like) to match the demand.

FIG. 1 illustrates a functional block diagram of a transportation system 100 of an embodiment of the invention. The transportation system 100 includes a fleet of vehicles (with “vehicle” being used interchangeably with “bus”) 110 and a ridership prediction and dispatching system 130 for processing measured or “actual” passenger use (ridership) of the buses 110 and to process this data to better determine demand for the buses 110. The demand is then used for forecasting future demand and then planning labor assignments and dispatching (e.g., routes, buses, frequency of runs, and so on) based on this more accurately forecasted demand.

To this end, each bus 110 may be outfitted or retrofitted to include an onboard data system or mobile data terminal 112 (e.g., a processor or computer-based system for managing communications, running software, managing hardware, and storing and retrieving data from memory such as storage 120). An automatic counter or APC 114 is provided on bus 110 to count passenger or people using the bus 110 and, more typically, for determining movement of people or counts in both directions (e.g., counting embarking or loading passengers as well as counting debarking or offloading passengers from the bus 110). A variety of APCs 114 may be used such as infrared beam-type APCs (e.g., passive IR counters, target reflective IR counters, active IR counters, passive optical, or the like), radio beam APCs, pressure pad-based APCs, magnetic APCs, induction loop APCs, and the like located on the path(s) of the passengers (e.g., near the door(s) of the bus 110). The signals from the APC 114 are processed by the data system 112 to log the counts of loading and unloading passengers (e.g., “OnCounts” and “OffCounts” in some embodiments). The onboard data system 112 may create or manage a set of APC data or APC data records based on these counts. In some cases, the counts are logged for each stop (e.g., for each origin or destination for the bus 110 on a route) by the data system 112 and stored in data storage 120 or transmitted after each stop via the wireless communication antenna 124 (or devices such as a built-in GSM or mobile phone modem or the like) as APC data 128 (with data sometimes being formatted or readily converted to spreadsheet or table format for read manipulation and data analysis by the ridership prediction system 130 including showing trends and matching demand to OD pairs). For example, at each stop, the APC 114 may act to generate a set of OnCounts and a set of OffCounts indicating, respectively, the number of passengers embarking and debarking from the bus 110 and these actual/real time counts are stored by the data system 112 in storage 120 with reference to the time, date, and other information.

Specifically, the other information tracked may include location information (e.g., which allows matching to the stop) and optionally a route ID and a vehicle ID. To provide location information, the bus 110 may include a location device 116 such as, but not limited to, an automatic vehicle location (AVL) component that uses a satellite-based global positioning system (GPS) antenna 118 to obtain the location of the bus 110 when the counts are made by the APC 114. The location information may be stored as raw location data in data storage 120 for transfer in APC data 128 or it may be used by the data system 112 to lookup a corresponding stop ID or location, with the stop ID/location being associated with the counts from the APC 114 in memory 120. Additionally, the system 130 knows or is aware of the route network and may store the route network information in memory 140. In some embodiments, commercially distributed computer aided dispatch/automatic vehicle location (CAD/AVL) products are used as part of the system 100 such as to provide the vehicle location components, communication components (such as antenna 124 and transceivers (e.g., part of I/O 134) at system 130), and a portion of the prediction and dispatching system 130 (such as dispatching consoles (e.g., monitors 136 and/or GUIs 138 or other devices not shown) for monitoring and managing dispatching of vehicles 110). Such devices may be used to provide functions such as engine monitoring, vehicle tracking, and destination marquee/signage control.

The collected APC data 128 is transmitted to the ridership prediction and dispatching system 130 such as after each stop or periodically (such every few hours or other fixed or variable time period). In other embodiments, though, the APC data 128 is stored in memory 120 and then downloaded or transferred to the system 130 in a wired manner or via transferred storage media (e.g., memory sticks, disks, or the like). The system 130 includes a CPU 132 for managing operation of I/O devices 134 such as keyboard, a touchpad/screen, a mouse, and wireless communication devices for receiving APC data 128. The I/O devices 134 may also include one or more printers for printing hard copies of OD pair data 158, demand profiles 160, labor assignments 162, dispatch schedules 166, and/or other output generated by the system 130. A monitor 136 is included to display information being processed by system 130, to display a GUI 138 that may facilitate data display and/or input by an operator (e.g., to adjust time period lengths used by OD pair translation module 170 or to adjust other processing variables or request particular outputs/reports), and/or to display outputs of the system such as OD pair data 158 and dispatch schedules/information 166.

The system 130 further includes memory 140 for storing data in digital form such as vehicle APC data (input data) 142 received from the buses 110. Other data used in processing the actual input data 142 may be stored in memory 140 including route definitions 144 as well as OD pair definitions 146. Bus routes are generally defined to include a plurality of stops or pickup/dropoff locations and end at a particular location or destination. However, each route may have numerous origin-destination (OD) pairs as passengers embark the bus at differing stops (differing origins) and, in some case, get off prior to the final destination creating another destination (e.g., a same origin stop may have more than one destination for the same route to create more than one OD pair for the same origin stop).

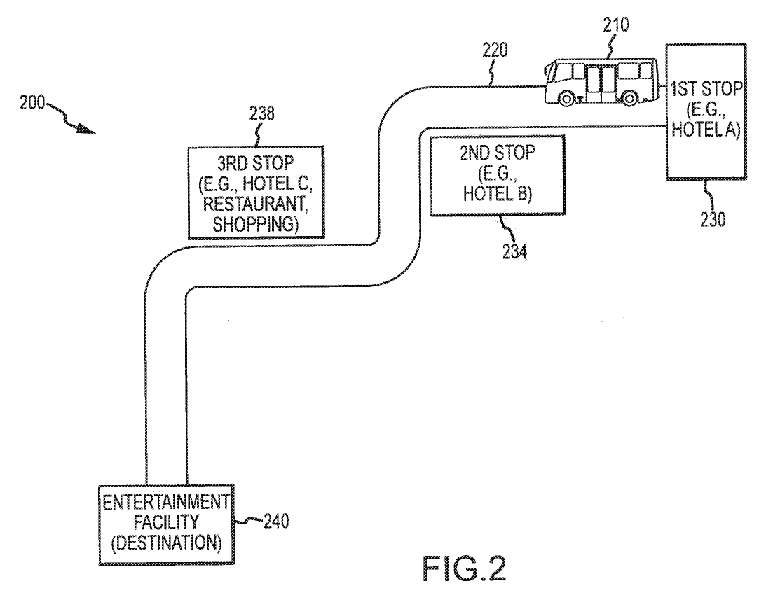

FIG. 2 illustrates a relatively simple transportation network or region 200 serviced by a transportation system with its buses 210. The route of the bus 210 may be the road or street 220. The route 220 may travel from a first stop (or hotel) 230 to an entertainment facility or other end destination 240. Also, the route 220 includes two intermediate stops 234, 238, and passengers may load at all tree stops (origins) 230, 234, 238. The passengers may debark from the bus 210 at the entertainment facility 240 but also at intermediate stops 234, 238, and this creates numerous OD pairs just for this simple route (e.g., 230-234, 230-238, 230-240, 234-238, 234-240, and 238-240) and just when considering this travel direction, with another set of OD pairs being defined for travel from entertainment facility 240 back to the first stop/hotel 230. This decision of whether to combine origins and destinations may be determined by the dynamic routing models/processes described herein. To better understand demand and, then, forecast demand and plan labor assignments and dispatching, it is useful to define routes and then for each route define OD pairs (as shown in memory 140 at 144, 146), and next to attribute the actual passenger counts/demand to these OD pairs. For example, such knowledge of demand may indicate that one or more buses 210 should be run on route 220 or one or more buses should be provided for subparts of the route such as to service particular OD pairs determined or forecasted to have heavy demand.

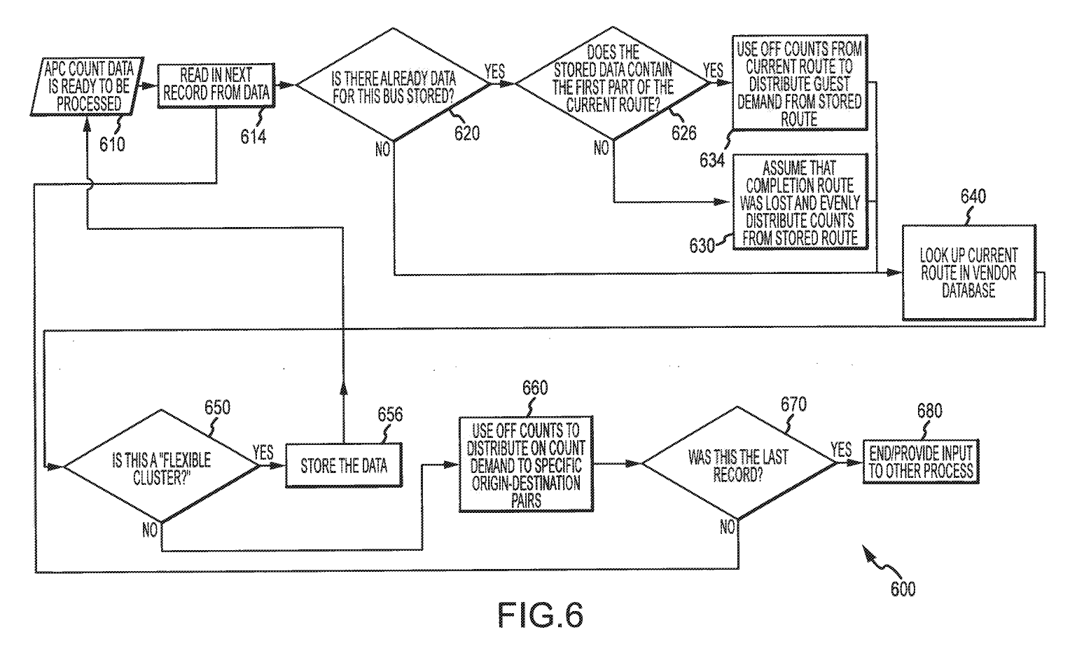

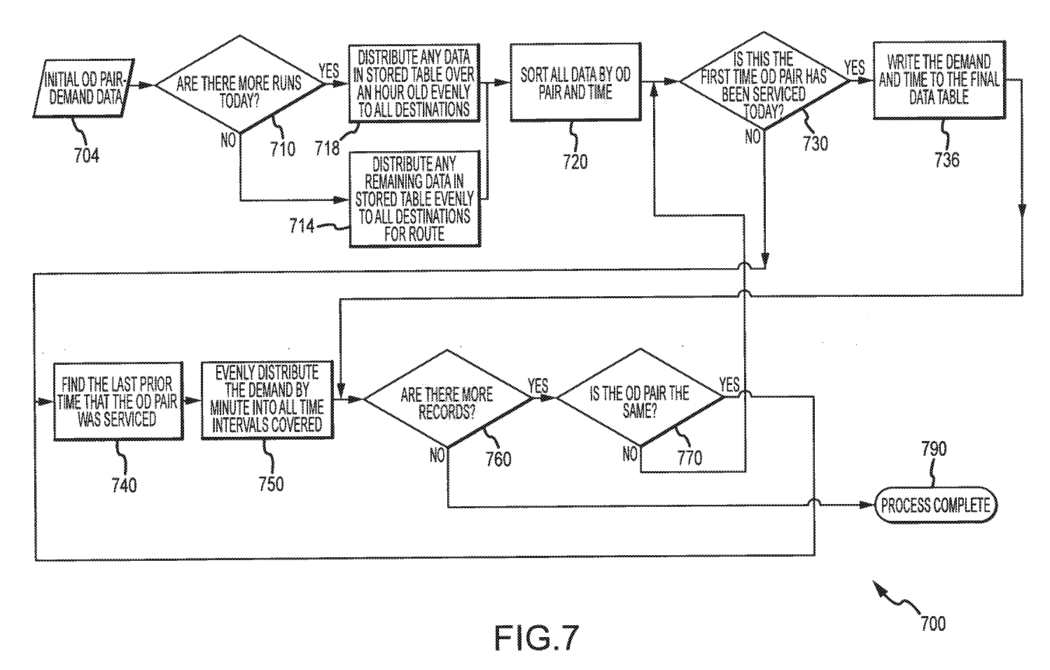

Referring again to FIG. 1, the ridership prediction and dispatching system 130 includes a passenger count-to-OD pair translation module 170 (e.g., software routine or the like provided in computer readable medium and run by CPU 132 to perform the described functions such as shown in FIGS. 6 and 7). Briefly, the translation module 170 processes the vehicle APC data 142 and generates OD pair data 1.58 stored in memory 140 and/or output to I/O devices 134 and/or monitor 136. The OD pair data 158 generally attributes the counts from the APC 114 to particular OD pairs of a route such as passenger counts or demand per predefined period of time (e.g., 15 minute intervals for each operating day for a bus 110 or vehicles on a route). The OD pair data 158 may be considered a portion of a set of forecasting input data 150, which may further include historical data 152 (such as attendance at an entertainment facility, lodgers or population of a resort or hotel complex, and so on) and operating parameters/information 154 (such as operating hours, special events, day of week for which forecast is desired, past or predicted weather, and so on). Any information referenced in operating parameters/information 154 has a historical counterpart in historical data 152.

The demand forecasting tool 180 may be run by the CPU 132 using the forecasting input data 150 including the OD pair data 158 to generate a set of demand profiles 160 (e.g., expected demand or passenger counts for each OD pair and/or bus route for future days/weeks/months per time period of the operating time). These demand profiles 160 may be stored in memory 140 and/or output as reports or displays (or as input to other processes) via CPU 132 such as using I/O 134 or GUI 138. For example, the system 130 includes a labor and dispatch planning module(s) 190, and this module 190 may process the demand profiles 160 with or without other data and generate labor assignments 162 assigning drivers and others to support a fleet of buses 110 and dispatch schedules 166 indicating for each route how many buses will service the route, when such buses are to be dispatched, and so on. The module 190 may also function to decide how to group OD pairs and select the routes to dispatch.

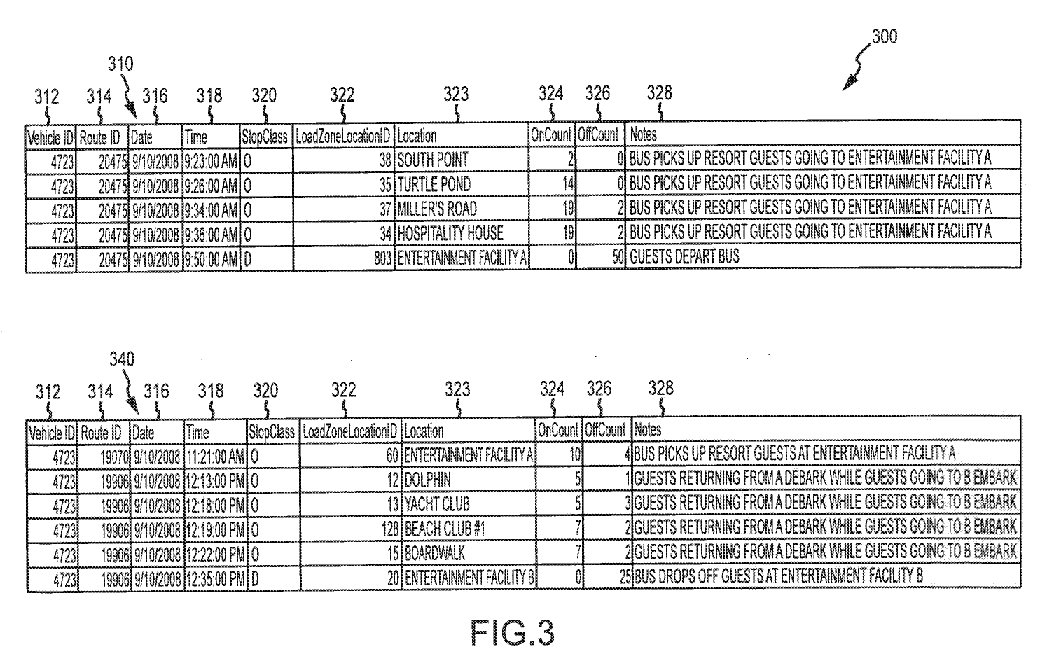

FIG. 3 illustrates an example 300 of vehicle APC data 142 created using an APC 114 of a bus 110 and/or providing further processing/data input by onboard data system 112 and/or components of system 130. As shown, the APC data set 310 (shown in table or spreadsheet form) is provided for one route while APC data set 340 is provided for another route. In each APC data set 310, 340, the data includes a vehicle ID 312, a route ID 314, a date 316 and time 318 that the data was collected/measured, and a stop class 320 (e.g., is the stop generally an origin stop for this route or a destination stop). Further, the data 310, 340 includes a location of the stop 323 (with a load zone location ID 322 associated with the location name/description 323) such as may be determined based on the GPS location data from AVL 116 and the route that the bus is servicing or the like (e.g., via a look up of the GPS location data to a stop in the vicinity of the GPS location of the vehicle at the stop). In some cases, the system only sends counts if it can match them to a stop on the route that the bus is operating at the time.

For each location/stop, the data 310, 340 also include APC-provided counts 324, 325 of people getting on and getting off the bus (e.g., the APC is direction sensitive). As shown, some stops are only origin stops or destination stops with all counts being in one direction (on or off) while some stops have people that embark and that debark (on and off at single stop). As a result, the overall oncount will often not equal the offcount at the final destination stop of the route. Further, in data 340, there are situations where there are riders already on a bus when it starts a route, which can result in offcounts at the first origin stop. In some embodiments, the assigning of counts to OD pairs may be relatively simple with all on counts of an origin stop being assigned to the OD pair (e.g., with one main destination such as the entertainment facility A in FIG. 3). However, in other embodiments as explained with reference to FIGS. 6 and 7, more detailed passenger/demand attribution is performed to account for passengers departing/debarking at more than one stop, passengers loading and unloading at single stops, and other parameters (such as how long did the passengers wait prior to being picked up such as to account for a bus having to pass by a stop because it was full and so on).

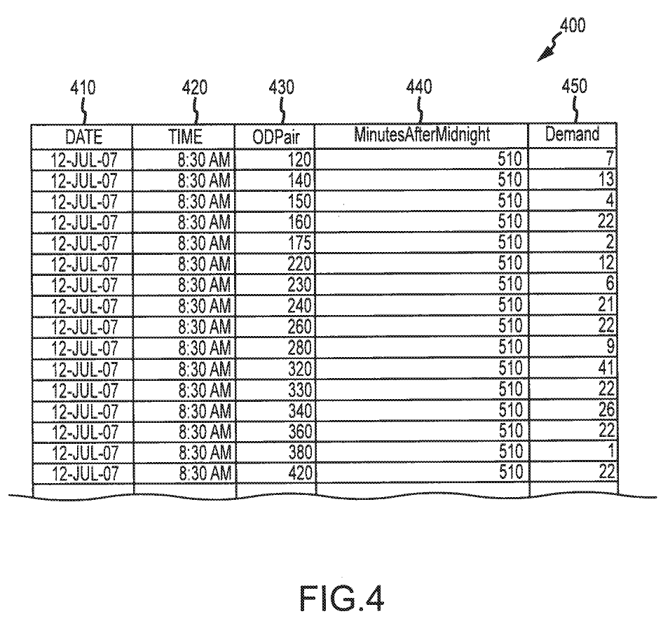

The APC data 300 (or 142 in FIG. 1) is processed by the passenger count-to-OD pair translation module 170 to produce a set of OD pair data 158. An example 400 of such OD pair data produced by module 170 is shown in FIG. 4. As shown, the OD pair data 158 includes a date 410 and a time period 420, 440 (e.g., starting time of an “x” minute interval such as a 15-minute interval, a 30-minute interval, or the like or period start time relative to a time of day like midnight as shown in FIG. 4) corresponding to the day and time the APC data was collected for one or more buses on a route (e.g. more than one bus may service a route and its OD pairs and such count data may be combined to produce demand for the OD pairs). The data 400 also includes an identifier of the OD pair 430 for which the demand corresponds, and this identifier (an integer being shown as a non-limiting example of an OD pair identifier) may be used to look up a description of the OD pair (e.g., its origin and destination locations). Significantly, the data 400 includes a demand value 450 associated with each OD pair 430 for each time period 420. The demand in this case is a count of passengers using the service during that time period, and demand data would be provided for each day the transportation service was provided (or APC data was gathered) and for the operating hours for the route/service. The granularity of information to the OD pair level provides surprising information or at least information that was unavailable under older systems that only provided dispatch information, with any demand information having to be manually collected. For example, it is clear that the demand is not equally divided among the OD pairs, with some OD pairs having a much higher demand than others, and the OD pair demand data may be used to enhance service (such as by providing a “route” or bus that begins service in the route at points of higher demand such as a bus that starts service with the 320 OD pair or the like).

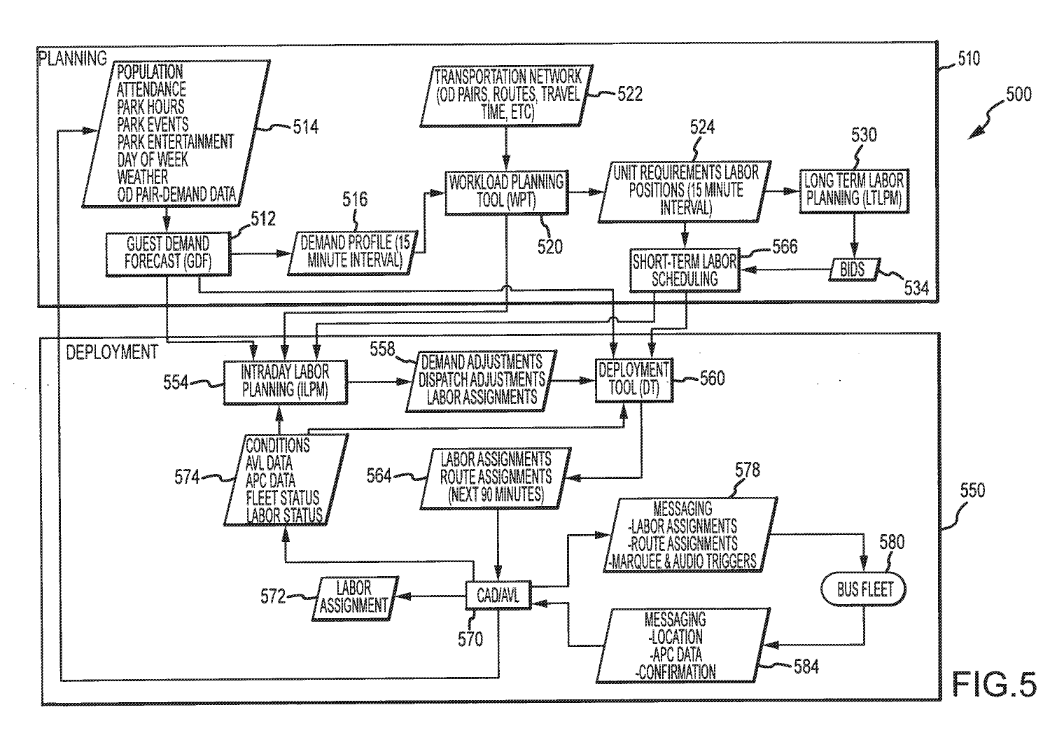

FIG. 5 illustrates a planning and deployment system 500 that may be implemented and utilized according to embodiments of the invention (such as by operation of the system of FIG. 1 with the software modules/algorithms/tools and data sets of system 500 having the same/similar or differing names but providing similar functionality). The system 500 is shown to include a planning subsystem 510 and a deployment subsystem 550. The planning subsystem 510 includes a guest demand forecast module 512 that processes input data 514 such as historical guest and passenger demand data and other property information to produce a forecast of future guest/passenger demand 516 (e.g., demand profiles for transportation services per time period). For example, the historical data 514 may include OD pair-demand data as shown in FIGS. 1 and 4 and may also include other property management data such as historical attendance of a facility/event, population of serviced hotels or local buildings, hours of operation, planned events/activities (such as concert, a sports game, a parade, and so on), day(s) for which forecast is required (as demand likely varies based on day of week, time of year, and so on), and historical/forecast weather during time period.

The planning subsystem 510 further includes a workload planning tool 520 that uses the demand profile 516 from the guest demand forecaster 512 along with transportation network data 522 (e.g., OD pair definitions, route definitions, travel times for buses on the route/OD pair, and so on) to determine service level for each OD pair, which may be stated as numbers of buses and/or drivers as shown at 524 with unit requirements/labor positions for each time interval (e.g., for time periods of demand profiles 516). The planning tool 520 may also function to optimally route buses and then to use these routing decisions to determine the bus workload for each operational day. A scheduling module 566 may be used to process unit requirement and labor position data 524 to provide scheduling information to processing tools of the deployment subsystem 550 (e.g., to pass-thru data 524 and/or to further refine the data to suit a particular scheduling, planning, and/or deployment tool). The data 524 from the workload planning tool 520 may further be fed to a longterm labor planning tool 530 that generates long-term bids or bidlines 534 that establish longer term worker and/or driver availability based on satisfying workload determinations 524 by planning tool 520 subject to other parameters (such as union rules, worker satisfaction metrics, and so on). Typically, bids are used to define a worker's availability or shifts over the next fixed periods of months. The bid data 534 may be used to limit the scheduling performed by module 566 and, hence, input provided to deployment subsystem 550.

Data generated from the planning subsystem 510 may be transferred to the deployment subsystem 550 for use in generating labor assignments and specific bus dispatching schedules based, at least in part, on the OD pair-demand data 514. For example, an intraday labor planning module 554 may receive input from the guest demand forecaster 512, the workload planning tool 520, and the scheduling tool 566. The intraday labor planning module 554 outputs labor assignments and adjustments to the demand and dispatches 558. The planning module 554 may look at all labor decisions for a time period (e.g., for the time period after operation of the deployment tool 560 to the end of the day) such as driver breaks, end of shifts, and other worker requests. The planning module 554 may operate to limit operation of the deployment tool 560 such as to prevent the tool 560 from sacrificing the needs of bus drivers to improve optimality of the bus routes and servicing passengers.

The deployment tool 560 takes output from the intraday labor planning module 554 as well as the demand forecaster 512 and the scheduling tool 566. The deployment tool 560 may be adapted to process this input to optimize an upcoming time period of operation of the managed transportation system (or bus fleet). For example, the tool 560 may process the input data and try to optimize the next 90 minutes of dispatch and labor assignments (with these optimized assignments output at 564). The optimized labor and route assignments 564 are fed to another software module labeled in FIG. 5 as the CAD/AVL module 570 (e.g., computer aided dispatch/automatic vehicle location). The CAD/AVL module may provide messaging 578 of labor assignments, route assignments, and, in some cases, output labor assignment reports 572 (for reporting to drivers and other workers in other messaging methods such as hard copies posted in a work area and the like). The messaging 578 is delivered (typically wirelessly as shown in FIG. 1) to the buses or vehicles of a fleet 580. The bus fleet 580 delivers messaging 584 back to the CAD/AVL 570 including APC data and location data, and this APC data is transferred directly or as shown from the CAD/AVL 570 to the demand forecaster 512 for use as input data 514 for performing demand forecasts including demand profiles 516. The CAD/AVL module 570 may also output data for use in labor and deployment by tools 554, 560 such as conditions, AVL data, APC data, fleet status, and labor/driver status.

With the above description understood, it may be useful to provide a more detailed discussion of translating APC data or counts into OD demand. In the following discussion (or some embodiments), the APCs are automatic people counters such as photocell-type devices that count passengers or riders as they embark and disembark from the bus (e.g., a device able to determine direction of flow/movement). The term “demand” may be thought of as a measure of how many passengers will be requiring transportation in forecasting terms. An OD pair is an origin-destination pair and demand is typically attributed or assigned to each pair (e.g., demand from a single origin to a single destination), with this typically being the lowest level of demand forecasted. A route is a grouping of origins and/or destinations that services the demand. For example, a route traveling from a resort to an entertainment facility or a natural attraction such as a beach or ski hill may cover three OD pairs (e.g., three stops within the resort complex such as three hotels/lodging buildings or three cross streets or the like). A “flexible route” may be a route with OD pair destinations that are not actually covered by the stops physically assigned to the route, and such an arrangement may happen when the bus is dropping off guests from one location (an origin) while simultaneously picking up guests/passengers for another destination (such that the stop is a destination for some passengers and an origin for others, which affects demand attribution in some embodiments).

Generally, demand information comes from APC counters on the buses in the form of oncounts and offcounts as well as including location of the demand (e.g., the GPS location of the bus) and route ID. The translating of the APC data includes determining whether complete route information has been received/processed or if the route is a flexible route. If the route is a flexible route, the attribution or translating process may wait until the counts from the next route are received to determine where guests exited from the bus. The translating process continues with using the oncounts for demand at each origin. If there are multiple destinations for the route, then the demand has to be distributed (in some embodiments) to the assigned OD pairs. To determine how many guests to assign to each OD pair, the translating in one embodiment includes looking at the departures at each of the destinations as a percentage of total departures. These percentages are then applied to the demand at each origin to calculate how much of the demand will be assigned to each destination from that origin. It is assumed that passengers have the same destination distribution regardless of origin.

FIG. 6 illustrates a count or APC data translation method 600 that may be utilized to assign raw passenger count data (oncounts and offcounts at each stop) to particular OD pairs. Generally, the method 600 may be implemented by a system such as system 100 that uses a translation module 170 to process vehicle APC data 142 retrieved from memory 140 or as it is periodically received 128 from operating vehicles 110 (e.g., module 170 may be provided in computer readable medium or memory and be configured to cause the computer to perform the steps or functions shown in FIG. 6). At step 610, the method 600 includes determining whether APC count data is ready to be processed (or receiving/retrieving a batch of such data such as the data for a particular day or the like). At step 614, the next record of data is read (e.g., one of the records from the data sets 310, 340 shown in FIG. 3). At step 620, the method 600 includes determining if there already is data stored for this bus in memory. If not, the method 600 continues at 640 with looking up the current route in a database (e.g., with the ID of the route and/or the location information provided in the APC data). Then, at 650, it is determined if this is a flexible route, and if so, the method 600 calls for storing the data 656 (e.g., the route ID and APC data in a record such as shown in FIG. 3) and then continuing at 610 with the next record 310, 340 of passengers getting on and/or off the bus.

If at 620 it is determined that data had previously been stored for this bus, the method 600 continues at 626 with a determination of whether the stored data contains the first part of the current route. To determine if the stored data is part of the current route, the system looks at which destinations were in the stored route's OD pairs but were not covered by the actual list of stops for the route. The system then looks to see if those uncovered destinations are in the current route's list of stops. If yes, at 634, the method 600 includes using the offcounts from the current route to distribute guest demand from the stored route. The method 600 continues with performing steps 640 and 650. When the route is determined to not a flexible route at 650, the method 600 continues with step 660 with using the offcounts to distribute oncount demand to specific OD pairs. For example, a route may have two stops where passengers debark or leave a bus (or where offcounts occur), and, hence, these two stops would be destinations. The origin stops to be paired with these two destination stops would be the stops where oncounts occurred before or upstream of these two destination stops. The oncounts are proportionally assigned to each OD pair (e.g., each upstream origin stop is paired with the downstream destination stops) to distribute the measured demand.

For example, the route may have 50 oncounts for the origin stops upstream of the 2 destination stops and 10 offcounts at the first destination and 40 offcounts at the second destination. In this example, at step 660, the oncounts would be proportionally assigned to each OD pair such that 20 percent were assigned to the first destination and 80 percent to the second destination (e.g., if 10 people got on a bus at a first stop of a route, the OD pair of this first stop and the first destination would have a demand of 2 passengers/riders whereas the OD pair of this first stop and the second destination would have a demand of 8 passengers/riders). The attribution 600 may ignore the oncounts at the first destination in this proportional calculation as it would be assumed that these oncounts were only upstream of the second destination and have to be assigned to the demand of the OD pair of the first destination stop (which is an origin when paired with the second destination) with all the oncounts being considered demand for this OD pair. As will be appreciated, the proportional assigning of oncounts based on the location of offcounts on the route is one useful method of assigning demand, but the invention may be implemented using other attribution techniques (and with some modifications as discussed with reference to discounting the oncounts at the immediately upstream stop for a final destination as these passengers are necessarily traveling to the next and last stop). Any oncounts at a location not considered an origin or offcounts not considered a destination for the routes covered will be disposed.

If at 626, it was determined that the stored data did not include the first part of the current route, the method 600 would include evenly distributing the counts to the OD pairs from the stored route (rather than performing proportional distribution as discussed above based on offcounts). At 670, it is determined whether there are additional records to process at this time. If so, the method 600 continues at 614, and if not, the method 600 may end at 680 or the OD pair-demand data may be stored in memory and/or output to other processes (as discussed with reference to FIGS. 1 and 5 for example) or used to generate a report/display. The stored OD pair-demand data generated via process 600 may take the form 400 shown in FIG. 4.

Two specific examples for FIG. 6 follow. For the first example, assume that a route servicing five origins and three destinations is completed. The counts recorded are as follows: O1, 15 on; O2, 18 on; O3, 21 on; O4, 0 on; O5, 3 on; D1, 12 off; D2, 24 off; D3, 0 off. In this example, one third of the passengers exited at destination 1 and two-thirds exited at destination 2. It will be assumed that all passengers at each origin will follow this distribution, such that the OD Pair demand results as follows: O1-D1, 5; O1-LD2, 10; O1-D3, 0; O2-D1, 6; O2-D2, 12; O3-D1, 7; O3-D2, 14; O4-D1, 0; O5-D1, 1; O5-D2, 2. All OD Pairs not listed have a count of zero and are left out for simplicity's sake. For the second example, assume that the route is servicing three hotels, A, B, and C, to a destination. When the system checks the stored data table, it finds a route for this same bus that has these three hotels as destinations. For this stored route, a count of 48 passengers was recorded at the origin Z. On the new route, counts of 24, 24, and 12 are recorded disembarking the bus at resorts A, B, and C, respectively. The exit counts are used to figure out a destination distribution of 40% at Resort A, 40% at Resort B, and 20% at Resort C. Multiplying the percentages by the on counts at the original origin leads to assigning 18 passengers to the Z-A OD pair, 18 to the Z-B OD Pair, and 9 to the Z-C OD pair. The on counts at each of these resorts will be recorded and will run through the process separately.

In many cases, it is desirable to further process the OD pair-demand data to determine and/or to reflect when guests/passengers really arrived at various stops (origins) for pick up service. For example, the data output 704 from the method 600 may be processed as shown in process 700, which functions to translate ridership numbers into demand over time. At 710, it is determined whether there are more runs 600 to be performed today, and, if not, at 714, any remaining data is distributed in the stored OD pair-demand table evenly to all destinations for a route (as discussed with reference to the specific examples for FIG. 6 in the preceding paragraph). If more runs will occur, at 718, the method 700 includes distributing any data stored in the OD pair-demand table over an hour (or other time period) old evenly to all destinations (again, as discussed with reference to the specific examples for FIG. 6 in the preceding paragraph). At 720, the data of the table is sorted by OD pair and time. At 730, it is determined whether this is the first time the OD pair under consideration has been serviced today. If yes, the method 700 writes the demand to the output table and continues at step 760 with a determination of whether there are more records to process.

If no, the method 700 continues at step 740 with finding the last prior time that the OD pair was serviced. At 750, the demand may be evenly distributed by minute into all time intervals covered. For example, if the OD pair was serviced 10 minutes ago and 50 passengers were counted, this may result in a distribution of 5 passengers/minute and such demand may be assigned to the OD pair based on the length of time intervals utilized. At 760, the method 700 determines whether more records are available for processing and if not the method is completed at 790 (such as after storing the OD pair-demand data, e.g., as shown in FIG. 4). If yes, the method 700 continues at 740.

A more specific example for FIG. 7 follows. Assume there are four records of demand for an OD Pair: 15 passengers at 10:04, 10 passengers at 10:14, 54 passengers at 10:32, and 16 passengers at 10:40. If these counts were assigned only to the 15-minute bucket in which they were noted, demand would be recorded as follows: 10:00-10:15, 25; 10:15-10:30, 0; 10:30-10:45, 70. This would make it appear as though no passengers wanted bus service between 10:15 and 10:30 when in all likelihood the majority of the 54 passengers picked up at 10:32 arrived during that interval. To rectify this issue, the counts are spread across the time intervals covered. The 10 passengers recorded at 10:14 would equal an arrival rate of one passenger per minute between 10:04 to 10:14, the 54 passengers would translate to an arrival rate of three passengers per minute between 10:14 to 10:32, and the 16 passengers would equal an arrival rate of two passengers per minute from 10:32 to 10:40. Taking these arrival rates and aggregating how much each arrival rate contributes to each 15 minute interval results in a new set of results: 10:00-10:15, 28; 10:15-10:30, 45; 10:30-10:45, 22. The passenger count for both sets of data is 95, but the counts after the translation are a much closer approximation to true demand than using only the actual ridership.

With a general understanding of translating APC counts into demand for OD pairs, it may be useful to present an example of a technique for effectively spreading the demand over particular operating time periods for a transportation system. To this end, the following is a specific, but not limiting, example of generating OD demand from APC data over 15 minute time intervals.

1) Disaggregate route data into OD Pair APC data
a. One-way routes with single origin and single destination
   i. Set OD Pair demand equal to the OD Route APC data at time of bus departure from origin
b. One-way routes with multiple origins and single destination
   i. Disaggregate route into single OD Pairs
   ii. Use number entering at each origin as the demand for the OD Pair at time bus left each origin according to rules above

2. Translate OD Pair APC data into OD Demand
a. For each OD Pair
   i. sort by time of day
   ii. process 1^{st} APC record (with assumption that all of the demand appeared within the last 15 minutes)
      1. Let t₁ equal the arrival time of the last guests (time associated with 1^{st} APC record)
      2. It t₀ equal the arrival time of the first guests
      3. Let w_{end} equal the end time of the previous window
      4. elapsedTime=t₁−t₀
      5. arrivalRate=count/elapsedTime
      6. Δt=w_{end}−t₀
      7. demandInLastWindow=Δt*arrivalRate
      8. Δt=t₁−w_{end}
      9. demandInCurrentWindow=Δt*arrivalRate
   iii. Loop over remaining APC records for this ID Pair
      1. Let t₂ equal the arrival time of the last guests (time associated with current APC record)
      2. Let t₁ equal the arrival time of the first guests (time associated with previous APC record)
      3. IF (t2 and t₁ are in the same window)
      4. demandInCurrentWindow=demandInCurrentWindow+count
      5. IF (t₁ is in previous window to t₂)
      6. Let w_{end} equal the end time of window associated with t₁
      7. elapsedTime=t₂−t₁
      8. arrivalRate=count/elapsedTime
      9. Δt=w_{end}−t₁
      10. demandInLastWindow=demandInLastWindow+Δt*arrivalRate
      11. Δt=t₂−w_{end}
      12. demandInCurrentWindow=Δt*arrivalRate
      13. IF (t₁ is in 2 windows prior to t₂)
      14. Let w_{end} equal the end time of window associated with t₁
      15. elapsedTime=t₂−t₁
      16. arrivalRate=count/elapsedTime
      17. Δt=w_{end}−t₁
      18. demandInLastWindow2=demandInLastWindow2+Δt*arrivalRate (demandInLastWindow2 references window associated with t₁)
      19. demandInLastWindow1=Δt*15 (demandInLastWindow1 references window after t₁ window and before t₂ window)
      20. let w_{end} equal the start time of the window associated with t₂
      21. Δt=t₂−w_{end}
      22. demandInCurrentWindow=Δt*arrivalRate
      23. IF (t₁ is in more than 2 windows prior to t₂)
      24. t₁=t₂−15
         (reset t₁ to 15 minutes prior and go to step 5)

According to some embodiments, a dynamic dispatching system is provided that generates bus dispatching assignments and labor assignments in real time (e.g., dynamically) in response to measured/determined ridership/demand changes (e.g., based on measured and/or processed real-time data) and/or business parameter changes. The dynamic bus dispatching/routing and generation of labor assignments may be performed, for example, by operation of the ridership prediction and dispatching system 130 of FIG. 1, such as with labor and dispatch planning module 190 outputting labor assignments 162 and dispatch schedules 166. In other cases, the dynamic bus dispatching/routing and labor assignment aspects of the invention may be provided by operation of the system 500 of FIG. 5 such as with the deployment subsystem 550 and operation of the deployment tool 560 and/or the intraday labor planning tool/module 554.

In operation of either system 100 or 500, the real-time data may be obtained from bus (or vehicle) equipment. This may include GPS-based devices that provide current location of the bus and hardware/software that calculates the estimated time of arrival and/or route completion. On-board computers and/or communication devices may also send bus information to a central command center, function to receive the most recently created dispatch schedule from the system 130 and/or subsystem 550, and also function to display the dispatch schedule to the driver.

The central command system (which may include the dispatching system 130 and/or components of system 500) may include and run two optimization models or modules (e.g., software programs or the like) that determine routing and labor assignments. First, the ILPM (Intra-Day Labor Planner Module) is included and configured to determine the dispatch and labor schedule for an upcoming period of time (such as the next 10 to 14 hours or more). It considers the same information as the second tool (i.e., the deployment tool (DT)) but has a longer time horizon. One main purpose of the ILPM is to provide a window for each service provider's such as driver's breaks to the second tool (e.g., the DT) and to determine any times during the day where the operation may not have enough drivers scheduled to satisfy guest demand or ridership. This tool ensures that the DT does not make any short-term decisions that would impact future service level. For instance, the DT could consistently push driver breaks to the end of the break window, which might be desirable for the short-term but may hurt service in the longer term. Second, the deployment tool (DT) is provided and used to determine the dispatch and labor schedule for an upcoming, relatively short period of time (e.g., next 60 to 120 minutes or the like with some of the following examples using 90 minute periods for the DT). The DT considers the next available time and location for each bus and driver, time of the next break (recommended from the ILPM) and end of shift for each driver, driver home location, manually added dispatches, last service time of each OD pair (origin-destination pair), and desired service interval for each OD pair. The DT uses an optimization algorithm in some cases to determine the bus assignments and may also use a detailed heuristic or other mechanism to determine driver breaks, swaps and non-driving tasks.

Both of the optimization modules may include two steps to derive a task schedule. Both may use network optimization to determine individual bus assignments to satisfy guest demand or ridership, and both may use a labor assignment heuristic that assigns drivers and vehicles to satisfy the assignments determined by the network optimization step/process. In some embodiments, the DT module or model is run every 5 to 15 minutes (or other useful time period) to allow the optimized schedule to be based on recent real-time data collected from the vehicles. The system 500 of FIG. 5 provides a system flow diagram that shows the interaction between the on-board equipment and the optimization models of some embodiments.

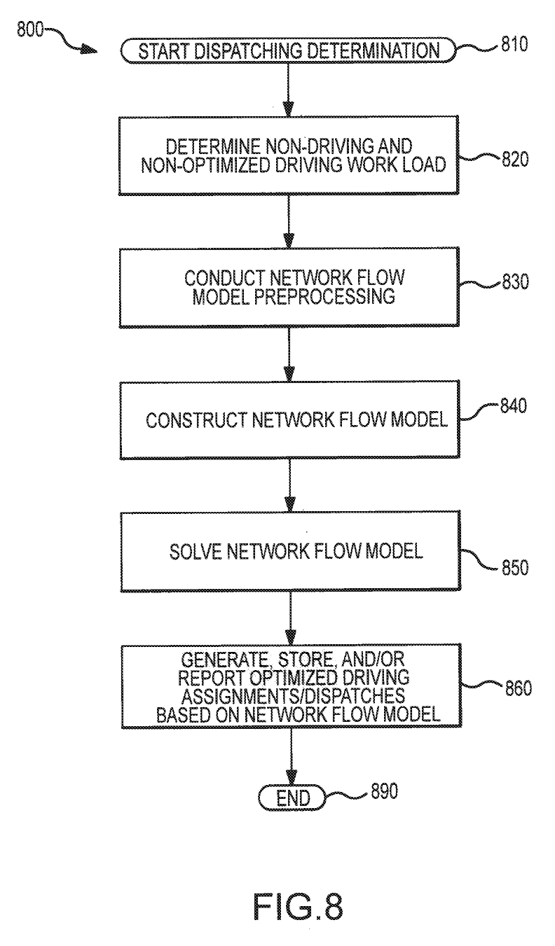

At this point, it may be useful to discuss how a transportation system may operate to determine dispatching assignments in a dynamic manner, e.g., based on real time collected information from the vehicles or busses carrying riders or guests on one or more routes (as may be defined by one or more OD pairs). FIG. 8 illustrates a method that may be implemented in one or more software modules run by a computer such as modules (e.g., tools 554, 560) of deployment subsystem 550 of system 500 to determine dispatching and also, in some cases, to determine aggregate workload. The dispatch determination 800 starts at 810 such as by loading software onto a computer such onto the ridership prediction and dispatching system 130 and transportation system 500 of FIGS. 1 and 5, and step 810 may also include equipping vehicles or busses as discussed above to facilitate real time data collection.

The dispatching determination 800 generally includes the steps of determining non-driving and non-optimized driving workload 820. The optimized driving workload is then determined through the use of a network flow model, and this includes conducting network flow model preprocessing 830. A network flow model may then be constructed at 840 to allow solving 850 of a network flow model. Optimized driving assignments (e.g., dispatch schedules 166 or the like) may then be determined after step 850, and step 860 may include generating, storing, and/or reporting optimized driving assignments/dispatches based upon the constructed and solved network flow model. The method 800 then ends at 890 (or is repeated periodically throughout a service period such multiple times per day to adjust dispatching as useful for providing a desired level of service based on changing demand or ridership). Each of these steps of method 800 is now explained in further detail.

At step 820, the non-driving workload may be derived directly from the user-entered position definitions for each operational day. An example of non-driving workload may be human dispatch coordinators and audience control. These position definitions may include checking position triggers, position start time rules, and position end time rules for each non-driving position against the operational data for the given day. Examples of position triggers include attendance, population, operational hours, number of businesses served, and the like. The start and end times of positions may then be used to determine the workload by a preset time interval. For example, the workload may be determined by 15 minute intervals such as for each hub of a transportation system or bus vehicle network such that a unit of workload is counted whenever a position requires any portion of the 15 minute time interval to be properly serviced. Non-optimized driving workload may also be derived directly from the user-entered position definitions for each operational day in the same or a similar manner as the non-driving workload.

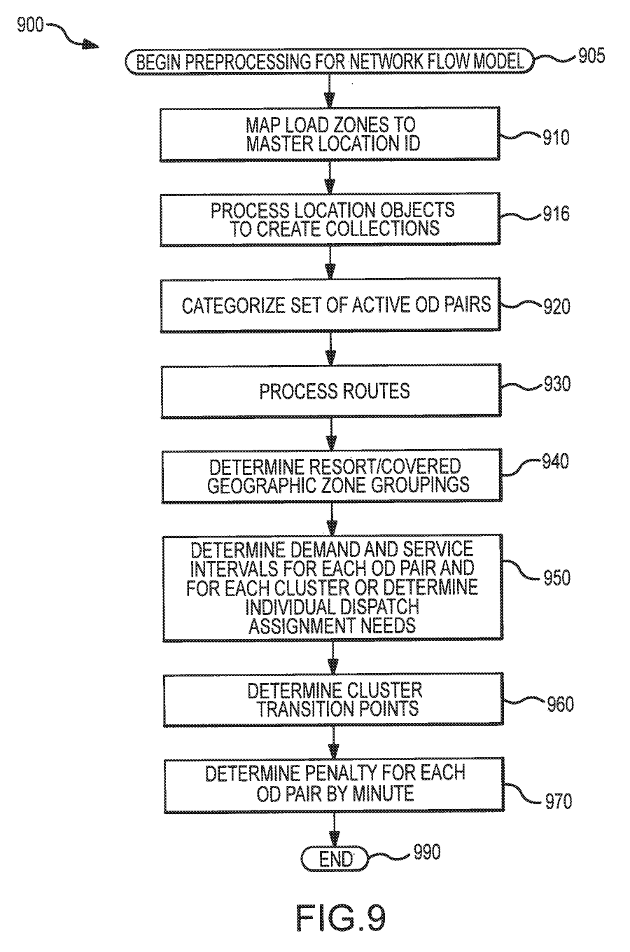

At step 830, preprocessing of the network flow model and/or specific data for use in such a model is performed to facilitate more efficient generation of the network flow model FIG. 9 illustrates steps of one exemplary preprocessing method 900 that starts at 905. In step 910, the preprocessing 900 of the network flow model (or data used in such a model) includes mapping load zones to master location identifications or identifiers (IDs). In step 910, all locations of a geographic service area may be reviewed with load zone group IDs (e.g., loadzoneGroupID) being replaced with a location ID of the “master location” of the load zone group. For example, this would be appropriate if there are multiple stops that serve the same destination, such as a resort with multiple bus load zones. In step 916, the location objects or locations are processed to create collections of subareas or components of the geographic service areas, e.g., for a resort or resort theme park application, the collections may include parks, hubs, resorts, staging areas, and so on.

At step 920, the OD pairs are processed to identify an active set or active category for the possible OD pairs for use in the network flow model. Step 920 may include determining a set of active OD pairs to be considered in a particular model run. An OD pair is active in this context if the “planning flag” or the like has been set to on. This task may further include categorizing each OD pair for use in the network flow model based on its function in moving riders/guests and/or busses within the transportation system or geographic service area. Such function categories may include resort to park (R2P), park to park (P2P), park to resort (P2R), park to staging area (P2S), staging area to park (S2P), resort to staging area (R2S), and staging area to resort (S2R). In step 930, the method 900 continues with processing the routes, which may include creating collections of deadhead routes and demand routes. A deadhead route is defined as a dispatch where the bus drives empty without any passengers. These routes ensure that service can continue even when demand is not present at a passenger dropoff location. For each OD pair, for example, step 930 may include determining routes that satisfy demand for the OD pair.

In step 940, the resort (or hotels or the like), service areas, covered geographic zones, or the lie are processed to create resort or service area groups. For example, in the resort setting or implementation, both R2P and P2R clusters may include groups of resorts. These groupings may be relatively consistent due to geographical and travel time considerations. Determining which resorts are grouped together is useful because the resort or service area (or pick up point) groupings indicate that there is more than one way to service the resort (or pick up point/location such as a bus stop). For example, service may be provided by dispatching to a cluster with the single resort as the origin (or destination) or by dispatching to a cluster with the resort as one of several resorts within the origin (destination) being a group for a dispatch. In step 930, the processing may include for each resort a review of all clusters. If the resort is in the cluster as an origin, flag all other origin resorts as part of a resort origin group. If the resort is in the cluster as a destination, flag all other destination resorts as part of a resort destination group. Then, the processing of step 940 may include creating a collection of clusters that can be used to satisfy the demand for any and all resorts in a particular resort or service area (pick up location(s)) group.

The method 900 continues at 950 with determining demand and service intervals for each OD pair and for each cluster. This may involve determining the demand for each OD pair by minute (or some other time period) by dividing the demand over the interval by the length of the interval. After this is completed for all OD pairs, the demand-driven interval (DDI) for each OD pair by minute (or some other time period) may be determined by stepping forward minute by minute, incrementing the accumulated demand by the demand in the next minute, until the targeted bus ridership has been reached. The time elapsed represents the DDI. The guest service interval (GSI) for each OD pair may be an input value or defined goal. The ideal service interval (ISI) is equal to the smaller of the DDI and the GSI. Note, the DDI and GSI may be used to determine a penalty value (if invoked) to apply minute-by-minute for the OD pair. The penalty is applied at the OD pair level, but dispatches may occur at the cluster level. This means that the DDI and ISI may be determined for all clusters that could possibly satisfy demand for a particular OD pair. Step 950 continues with looping over the resort groups to determine the DDI for each cluster associated with the group. For clusters with a single origin and a single destination, the value is simply the DDI and ISI of the OD pair. For clusters with multiple origins, the aggregate DDI of the origin is calculated (e.g., spaced approximately for travel time between origins).

In step 960, the cluster transition points are determined. For each active OD pair by a preset time period (such as 15 minutes or the like), the software tools/modules determine a valid cluster(s) that “cover” the OD pair, with a cluster “covering” an OD pair if the cluster moves demand from the origin of the OD pair to the destination of the OD pair. To determine the valid set of clusters for each 15 minute interval, the software tool(s) first collect all clusters that cover the OD pair. The software tool(s) then checks the DDI of the cluster during the time period under consideration. If the DDI that falls within the desired service interval window, the software tool(s) adds the cluster to the valid set of clusters that cover the OD pair. The minimum value of the desired service interval window will be the user-entered value while the maximum value will be the GSI of the OD pair. If no clusters exist in the set (i.e., no clusters that cover the OD pair have a DDI that falls within the desired service interval window), then the software tool in step 960 looks for covering clusters with a DDI outside of the desired service interval window (e.g., at least one cluster that covers each active OD pair is included in the model). The tool then examines all covering clusters with a DDI larger than the maximum value of the desired service interval window. If any exist, then the software tool selects the cluster with the smallest DDI. If none exist, then the software tool may collect all covering clusters with a DDI smaller than the minimum value of the desired service interval window. If any exist, then the software tool may select the cluster with the largest DDI. If none exist, then the software tool removes the OD pair from consideration. Note, also, that some clusters may cover multiple OD pairs. This process is followed to both limit the clusters that can be serviced to limit the dataset and to also ensure that there is not multiple combinations of OD pairs when the demand is high, which may result in overcrowded vehicles.

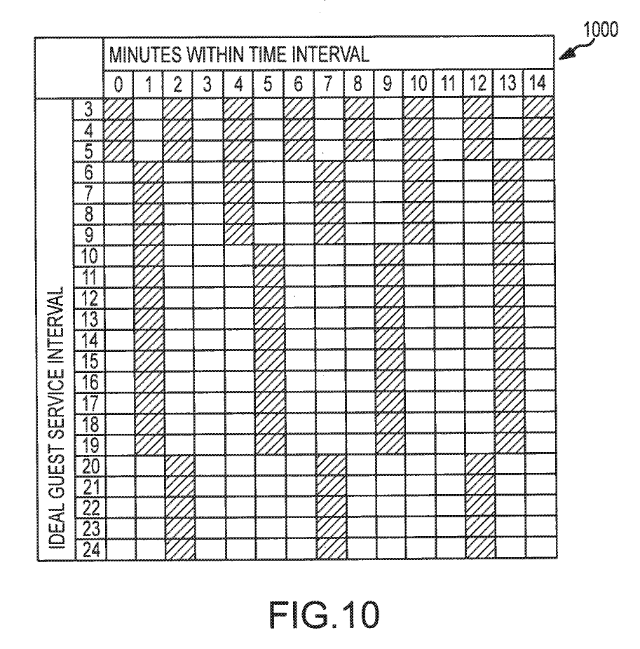

Once the software tool has collected a set of valid clusters for each 15 minute window of the day (or operating period), arcs may be added that allow dispatches over the valid clusters to occur during the 15 minute or other service window wider consideration. An exemplary alternative matrix 1000 is shown in FIG. 10 that may be used by the software tool to determine the number of alternatives that may be included within the window. In the matrix 1000, network flow alternatives are shown for a time interval as a function of an ideal guest service interval. This alternative matrix limits the size of the dataset and does not significantly impact service plan due to the graduated number of time alternatives based on ideal guest service level.

For example, consider a first OD pair (labeled SP-EC in the following discussion) at 8:00 AM. There may be three clusters that cover this OD pair, which may be labeled SP-EC, SP-MO-EC, and SP-MO-MU-EC. Each of these three clusters may have a different DDI (e.g., Cluster 1 (named SP-EC) may have a DDI of 17 minutes, Cluster 2 (named SP-MO-EC) may have DDI of 12 minutes, and Cluster 3 (named SP-MO-MU-EC) may have a DDI of 7 minutes). If the minimum desired service interval window is set to 7 minutes and the GSI of the OD pair is 15 minutes, then Clusters 2 and 3 would be considered by the software tool to be valid clusters for this particular time window. Alternative arcs for dispatching Cluster 2 would then be inserted at the following times: 8:01 AM, 8:05 AM, 8:09 AM, and 8:13 AM. Alternative arcs for dispatching to Cluster 3 would then be inserted at the following times: 8:01 AM, 8:04 AM, 8:07 AM, 8:10 AM, and 8:13 AM. If the minimum desired service interval window was set instead to 8 minutes and the GSI of the OD pair is 17 minutes, then the software tool may consider Clusters 1 and 2 as valid clusters for this time window. Then, alternative arcs for dispatching to both Clusters 1 and 2 may be inserted at the following times: 8:01 AM, 8:05 AM, 8:09 AM, and 8:13 AM.

The preprocessing 900 continues then at 970 with determining of a penalty of each OD pair (by minute or other time period used in the software tool(s)), and then the preprocessing 900 ends at 990. The value of the penalty to be applied when stretching is a function of the DDI and the GSI, which are both functions of the demand. Therefore, the value of the penalty can be precalculated and applied when stretching occurs. A number of penalty functions may be used to implement embodiments of the invention. The following is an example of one penalty function that may be utilized by the software tool(s), and the actual penalty function that is used may be determined during calibration of the network flow model.

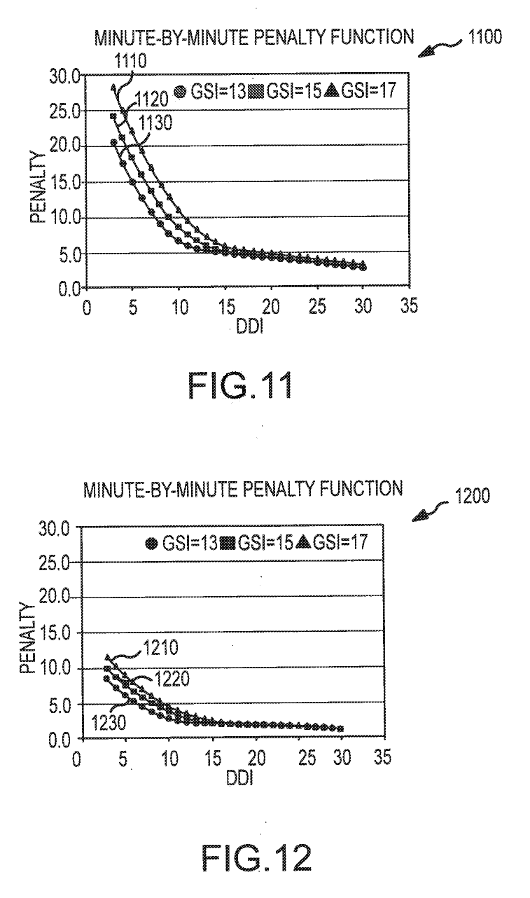

For example, if the DDI is less than the GSI, the penalty function may be defined as: 5+(GSI−DDI)²(1/0.5GSI). Whereas, if the DDI is greater than the GSI, the penalty function may be defined as: 5−0.15(DDI−GSI). An example for GSI of 13, 15, and 17 is shown in graph 1100 of FIG. 11 with lines 1130, 1120, and 1110, respectively. The graph 1100 shows the general shape of a desirable penalty function, though it may be fine tuned through testing of an embodiment of the invention. For example, the magnitude of the penalties may be scaled up or down so that it compares more appropriately with the cost of operating a bus, e.g., as shown in the graph 1200 with lines 1210, 1220, 1230. The penalty value may be added to the objective function as a cost that is applied any time an OD pair has a dispatch that is stretched. The penalty function can be determined based on evaluating different schedules, but, in general, the penalty may be higher for lower DDIs to ensure service is maintained during periods of high demand.

Returning to FIG. 8, the dynamic dispatch determination 800 continues at 840 with the construction of a network flow model. In network flow formulations, the minimum cost flow can be found given a capacitated network (G=(N, A), with nodes N and arcs A). Arc costs and arc capacities may also be considered in this formulation or determination (and represented, for example, by variables c and μ). Similarly, source and sink nodes are used in such formulations (and represented, for example, by variables s and t). Additionally, the network flow formulations consider the number of vehicles or busses (represented, for example, by variable n). Yet further, the formulations may define the minimum cost flow as the flow over arcs that satisfy all arc capacity constraints while maintaining conservation constraints on all vertices of the graph, except for the source and sink. A minimum cost network flow formulation may be stated as:

$$\begin{matrix}Minimize {\sum }_{( i , j ) ∈ {A}^{′}} {x}_{i , j} {c}_{i , j} \\ Subject to \text{:} & ( 1 ) \\ {\sum }_{( i , j ) ∈ {A}^{′}} {x}_{i , j} - {\sum }_{j \text{:} ( j , i ) ∈ {A}^{′}} {x}_{j , i} = 0 & ( 2 ) \\ {\sum }_{( s , j ) ∈ S} {x}_{s , j} = n & ( 3 ) \\ {\sum }_{( j , t ) ∈ T} {x}_{j , t} = n & ( 4 ) \\ 0 \leq {x}_{i , j} \leq {μ}_{i , j} \\ for each ( i , j ) ∈ A \\ Where n is the number of busses available & ( 5 )\end{matrix}$$

In the above formulation, A is the set of arcs, S is the set of arcs originating at the source, T is the set of arcs flowing into the sink, c_{i,j} defines the cost of sending flow between nodes i and j, and A′ is the set of arcs that do not either originate at the source or terminate at the sink. The resultant flow, x_{i,j}, is the number of units sent between nodes i and j. The dynamic network expands this formulation including adding constraints that encourage guest satisfaction and enforce resource limitations. Additionally, the objective function may include penalties for stretching, penalties for not meeting guest movement, and bonuses for sending buses to bonus staging areas during the requested time of day. A detailed description of the nodes, arcs, constraints, and objective function that will compose this formulation is provided in the following paragraphs.

Once the network flow has been built, a two-step hybrid approach may be used to generate a solution to the dispatch assignment problem. The first step in such an approach may be to convert the formulation to a pure network flow model that can be solved using linear programming techniques instead of integer programming techniques to generate a warm-start solution to the original integer problem. The conversion may consist, in some cases, of modifying the bounds of the arcs, setting both lower and upper bounds to zero (e.g., restricting this choice) or one (e.g., enforcing this choice). This step is taken to ensure a feasible solution exists and allows the heuristic a better starting point than if there was no an initial feasible solution. The second step in this approach uses a heuristic to improve the solution via bounds modifications, with the heuristic is guided by the previous solution. When the warm-start solution is within acceptable tolerances, the lower and upper bounds will be reset to their original values and the problem solved using integer programming techniques.

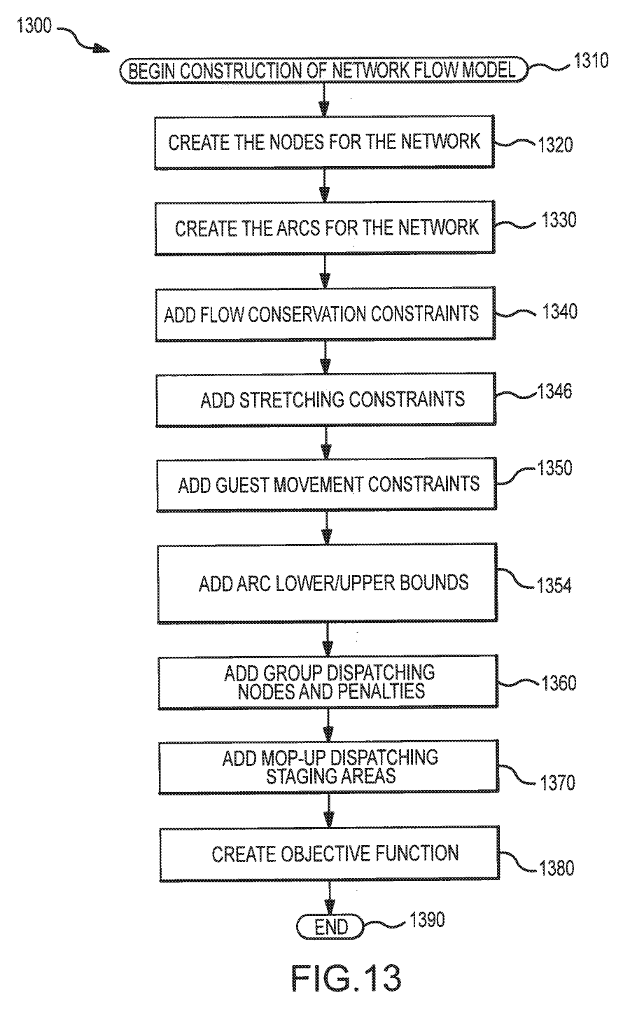

FIG. 13 illustrates in more detail a method 1300 for performing the construction of the network flow model (e.g., for carrying out step 840 of method 800 of FIG. 8). The method 1300 may begin at 1310 after preprocessing has occurred. The steps of method 1300 are used to construct the mathematical formulation of the network flow model that may then be carried out by a computer to facilitate generating a dynamic dispatching of a plurality of buses or similar passenger-carrying vehicles. At 1320, the nodes of the network are created. In general, the network nodes represent physical locations within a bus service area (or coverage area for a transportation system) such as load zones at a resort property or the like at specific times of day.

A first node may be a “Super Source” node that represents the pool of buses available for use. The specific time associated with the Super Source node is irrelevant though it should be before the time associated with other hubs/nodes. Physical locations such as parks (e.g., destinations of riders or guests such as theme parks, entertainment facilities, and so on), which may be both hubs and non-hubs, may be created at one minute (or other time) intervals for the time period under consideration. Likewise, resorts (or other guest/passenger/rider pick up points) and staging areas (which may be bonus-related and non-bonus-related) are also created at time intervals (such as one minute intervals) for the time period under consideration. A sink (sometimes labeled “FIW” to indicate a central maintenance facility) may also be designated for the network formulation and have a time that is later than any other node in the network. Additionally, nodes that represent times of day when buses become “unavailable” (e.g. for driver training) and “available” should be included. This allows the user to manually remove the bus from the solution without changing the network model. A summary of one set of useful node types may include: Super Source, Hub Source, Hub, Resort, Park, Staging Area, Bonus Staging Area, FIW/sink, Unavailable, and Available. The sink or FIW may be pre-processed to ensure that the proper number of buses is sent to FIW before the next operational day. This number may be a minimum number of buses per time period that need to be sent to the sink or FIW. Post-processing may be used to determine the actual timing. Note, if a node does not have dispatches associated with it (which may be determined after all of the arcs have been added to the model), then these nodes may be removed to the model to improve runtime.

Once the nodes have been created, the method 1300 may continue at 1330 with creating the arcs of the network. The arcs within the network represent the movement of buses throughout a service area (or geographic coverage area for a transportation system such as property of a resort complex or the like) as well as representing passage of time. Therefore, it is preferable to only connect nodes of the network when the travel time between the nodes is less than or equal to the difference in time associated with the two nodes. There are a variety of different arcs that may be added to the network, and they may be added incrementally.

In one embodiment, source arcs may be added to represent flow of buses into the network while idle arcs may be added to represent buses remaining at the same location as time passes. Deadhead arcs may be used to represent bus dispatches that do not satisfy guest demand whereas demand arcs may be used to represent bus dispatches that satisfy guest demand. FIW or sink arcs may be used to represent bus dispatches to the FIW or sink. Source arcs may include: (a) Super Source to Hub Source; (b) Hub Source to Hub (e.g., every 15 minutes); (c) Hub to Unavailable (at a defined time); and (d) Available to Hub (at defined time). Idle arcs may include: (a) Hub minute-to-minute; (b) Hub Non-workload (e.g., length of X to 2X minus 15, where X is the minimum shutdown time); (c) Park minute-to-minute; (d) Resort minute-to-minute; (e) Staging Area minute-to-minute; (f) Stage Area Bonus (e.g., for early morning 15+X and 30+X minute arcs, on 0/15/30/45, with deadheads out to particular parks/destinations with guided cost determinations on the deadhead; note, the capacity on the overlapping arcs may not exceed the number of buses possible in the staging area bonus); and (g) Unavailable to Available. Deadhead arcs may include: (a) P2P; (b) R2P; (c) P2R; (d) R2R (e.g., 5 closest; auction on multi-stop resorts/pick up or drop off points); (e) P2S; (f) R2S (e.g., 2 closest; plus bonus Staging Areas); (g) S2P; and (h) S2R (e.g., 5 closest). Demand arcs may include: (a) R2P (single resorts and clustered resorts); (b) P2R (single resorts and clustered resorts); (c) P2P; and (d) P2R2P. FIW/Sink arcs may include: (a) from Resorts; (b) from Parks/Hubs; and (c) from Staging Areas.

After the nodes and arcs are created, the method 1300 may continue with adding flow conservation constraints at 1340. Flow conservation constraints, for example, may be added to ensure the number of buses that flow into a node equal the number of buses that flow out of the node (except for Super Source node and FIW/sink node). The constraint may be stated as:

$${\sum }_{i i n} {x}_{i , j} - {\sum }_{i out} {x}_{j , i} = 0$$

The method 1300 may also include at 1346 adding stretching constraints. Stretching constraints may be added to the model for each OD pair for each minute of the day that the OD pair is active. These constraints may be used by the software tool to determine whether the demand is satisfied within a particular timeline based on the on an IGI (or ideal guest service interval). If demand is not satisfied, the service interval may be stretched, and a penalty applied in the objective function. The stretching constraint may take the form:

$${\sum }_{For all i i n \{ I \}} {x}_{i} \geq {P}_{O , D , T}$$

where set {I} is the set of all dispatches that could satisfy the demand of the OD Pair at time T. The software tool may be adapted to assume that at time T-1 a dispatch has just occurred that satisfied the demand from origin O to destination D. P_{O,D,T} will be equal to 0 if the penalty is to be applied, and it will be equal to 1 if the penalty is not to be applied. These stretching constraints ensure that the dispatches can be met even if there are not enough buses to satisfy the ideal guest service interval for each OD pair.

At step 1350, the method 1300 includes adding guest or rider movement constraints. To ensure that enough buses pass through high demand OD pairs, guest/rider movement constraints may be added to the network flow model. Due to runtime concerns, these constraints may be added only to high-demand OD pairs during times of the day when peak demand is achieved. The constrains may be of the form:

$${\sum }_{t = {t}_{0}}^{{t}_{f}} {x}_{o , d , t} + {q}_{0} \geq n$$

This constraint ensures that from time period t₀ to t_{f}, at least n busses are sent from origin o to destination d, where n=(total demand over the time period)/(targeted bus ridership) and q₀=the number of buses short of the required number. To allow for times when sending the required number of buses during the time period in question is not feasible, the variable q₀ will be added to the above constraint and to the objective function. This variable permits less than the required number of buses to be dispatched, though there will be a penalty applied in the objective function for each bus short of the required number. These constraints ensure that passenger demand is met over a timeframe even if individual intervals are stretched.

The method 1300 may also include adding arc bounds such as upper and lower bounds. The following table provides a list of such bounds that may be provided by arc type in the network flow model.

| Arc Type | Lower Bound | Upper Bound |
|---|---|---|
| Super Source | Minimum number of buses | Maximum number of buses |
| to Hub Source | assigned to the hub | assigned to the hub |
| Hub Source to | 0 | Maximum number of buses |
| Hub | | assigned to the hub |
| Deadheads | 0 | Some small number (e.g., 3 |
| | | to 7) |
| Staging Area | 0 | Individual staging area |
| Idle | | capacity |
| Bonus Staging | 0 | Individual bonus staging |
| Area Idle | | area capacity |
| Hub Idle | 0 | Individual hub capacity |
| Resort Idle | 0 | Some small number (e.g., 3 |
| | | to 7) |
| Hub to | Maximum number of | Maximum number of |
| Unavailable | unavailable | unavailable |
| Unavailable to | Maximum number of | Maximum number of |
| Available | unavailable | unavailable |
| Available to | Maximum number of | Maximum number of |
| Hub | unavailable | unavailable |
| Demand Arcs | 0 | 1 |
| To FIW | 0 | Some small number (e.g., 3 |
| | | to 7) |
| FIW to Sink | Minimum number of units | Maximum number of units |
| | to be processed per 15 | to be processed per 15 |
| | minute period | minute period |

The method 1300 may further include adding of group dispatching nodes and penalties. During group dispatching, the software tool(s) may use the same or, more typically, a different set of nodes and penalties than used in standard dispatching. For example, the nodes for group dispatching may be chosen such that they no longer represent the demand from an origin to a single destination but will, instead, represent the aggregate demand from, for example, a park (or other pick up point) to a group of resorts (or other destination). The assignment down to a particular resort may be handled by the operator or human-in-the-loop.

In standard dispatching mode, the penalties function on a minute-by-minute bases and represent stretching a dispatch interval. In group dispatching mode, the penalty is based upon the time that a guest has to wait at the load zone or pick up location before entering a bus. To model this situation, the group dispatching time window may be divided into overlapping blocks of time called demand windows in some cases. The aggregate guest demand of the exit group during the demand window may then be determined. The final step may be to check to see if enough buses satisfy the guest demand of the exit group during a time equal to the demand window plus the user-entered targeted wait time, with this window called the service window in some cases.

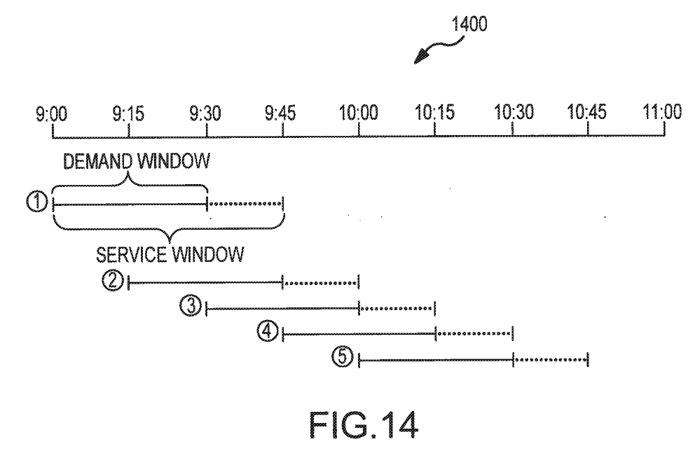

In one example, it is assumed that the time block for penalties is equal to 30 minutes, the user-entered targeted wait time for an exit group is equal to 15 minutes, and group dispatching is in effect from 9:00 PM until 10:30 PM. In this example, there are five constraints added to the network flow model for each 30 minute window (e.g., starting every 15 minutes) from 9:00 PM until 10:30 PM. A graphical representation 1400 of the five demand windows for this group dispatching example is provided in FIG. 14. The constraints may be in the form:

$${\sum }_{t = {t}_{0}}^{{t}_{f + 15}} {x}_{O , {G}_{m} , t} + {q}_{1} \geq n$$

Where x_{O,Gm,t}=1 if a bus is dispatched from origin O to exit group Gₘ at time t and 0 otherwise; t₀=initial time of time block being considered; t_{f+15}=end time of time block being considered plus the targeted wait time; q₁=the number of busses short of the required number; and n=the demand from time period t₀ to t_{f} divided by the targeted ridership during group dispatching.

This ensures that from time period t₀ to t_{f+15}, at least n buses are sent from origin O to destination exit group Gₘ. The variable q₁ represents the shortfall of buses during the service window and is included to ensure feasibility, since there will be times when the targeted wait time cannot be met due to high demand. This variable will be included in the objective function, inducing a penalty for each bus shortfall during the service window. More specifically, n will be calculated at follows:

$$n = \frac{{\sum }_{t = {t}_{0}}^{{t}_{f}} {d}_{O , {G}_{m} , t}}{{R}_{tgt}}$$

Where d_{O,Gm,t}=demand from origin O to exit group Gₘ at time t; t₀=initial time of time block being considered; t_{f}=end time of time block being considered; and R_{tgt}=the targeted ridership during group dispatching for this exit group. One important note is that the overlapping time intervals ensure that dispatches that are not serviced in one of the intervals get carried over to a future time interval.

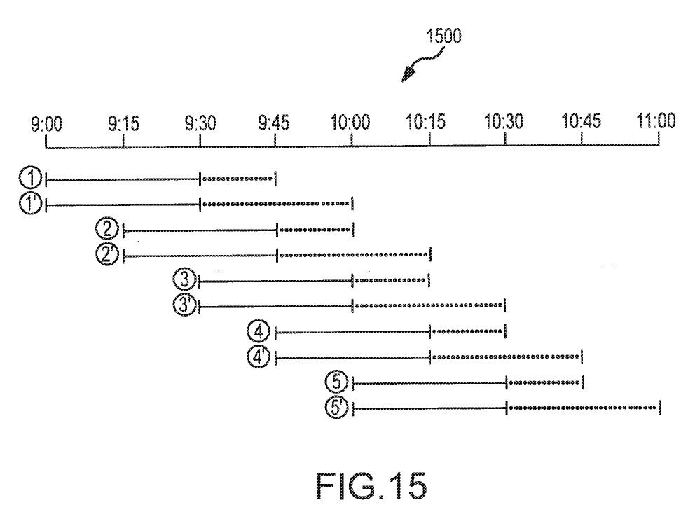

In addition to the constraints based upon the targeted wait time, constraints may also be added based upon the maximum targeted wait time. Extending the example above, the maximum targeted wait time may be 30 minutes, and the graphical representation 1500 is provided in FIG. 15. Again, these constraints are in place to ensure feasibility and will be of the format that follows:

$${\sum }_{t = {t}_{0}}^{{t}_{f + 30}} {x}_{O , {G}_{m} , t} + {q}_{2} \geq n$$

The penalty incurred by variable q₂ will be much larger than the penalty incurred by variable q₁. The exact value of the penalties, as well as the size of the demand windows, will typically be determined during calibration. Note, the constraints listed above may be used to ensure that the correct number of buses is assigned to the group, and they do not necessarily ensure that the spacing/timing of buses is adequate. If a problem exists with such bus spacing, it may be addressed and/or remedied in the post-processing stage or by other techniques. Another possibility is to include a human in the loop to control traffic flow, such as the exiting of an amusement park or a sporting event.

The method 1300 further includes adding mop-up dispatching staging areas in step 1370. Mop-up dispatching may be handled with staging areas such as to “mop-up” additional guests or servicing problems not handled by regular dispatching that may occur with sudden large ridership or guest demand. The software tool(s) may generate node/arc combinations within the network flow model during the time in question and will modify the objective function to include a “bonus” for flow over these arcs. At step 1380, the method 1300 includes creating the objective function. The software tool(s) may create an objective function that is adapted to minimize cost. The objective function creation approach begins by forcing the flow of buses into the network from the source. After the buses are in the network, cost may be minimized until the buses can leave the network and flow into the FIW. The cost may be set to be the sum of operating costs (e.g., driver and bus costs) plus penalties less any bonuses. Note, costs can be reduced in a number of ways including sending buses to non-workload idle at hubs, reducing penalties incurred by stretching dispatches, and reducing penalties incurred by not satisfying guest demand. Bonuses are incurred by sending buses to bonus staging areas during the user-defined time windows.

Returning again to FIG. 8, the method 800 continues now with the solving of the network flow model at 850, which may involve the use of a warm start. A purpose of the warm start heuristic is to quickly find a good feasible solution to the model. Experiments with the prototype of the model demonstrated that the software tool(s) sometimes may struggle when searching for an initial feasible solution. In some cases the quality of the initial solution was relatively poor and improvement relatively slow. Generating a good feasible solution up front may be used to eliminate the risk of the software tool(s) failing to find an acceptable or feasible solution within an allotted or desired time and expedite the search for a near-optimal solution.

A primary obstacle to overcome with respect to feasibility is the number of units available to the system during each 15 minute interval. Any solution that requires more units than are available at any given time may be infeasible. Therefore, one useful warm start is chosen and/or adapted to converge towards a solution that operates within the user-specified unit constraints. The quest for optimality may be complicated by the enormous number of possibilities for satisfying demand for each OD pair, the dependence upon the timing between subsequent dispatches to determine penalties, and the fact that the side constraints for enforcing penalties transform the otherwise “easy” network flow problem into a MIP (Mixed Integer Problem), which is a much “harder” problem to solve. Insight into the nature of the problem structure allows the warm start to navigate these issues more effectively than a generic solver.

The challenge, then, is to get a “good” feasible solution that respects user-specified unit availability. In this context, goodness is measured by the objective function of the model. Several major components of the objective function are: operating costs to include both labor and equipment; penalties for poor service of demand at OD pairs; and bonuses acquired by sending buses to staging areas during peak demand times. Improving a solution may mean lowering operating costs, improving service, or increasing staging area presence. The resultant model could be described as having two distinct phases: Phase 1 involving determining the dispatches to meet guest satisfaction requirements and Phase 2 including determining how the buses may be moved to meet the dispatches (if possible).

Therefore, the warm start typically is configured to make a trade-off between feasibility (in terms of units available) and optimality (in terms of operating costs, service, and backup units). The basic algorithm followed is or process steps are as follows. A first step may include creating a model formulation with all arcs and network constraints omitting penalty constraints and unit restrictions by time. This produces a formulation for the warm start up that maps directly to the model run in the software tool(s). Only one model is typically built, and feasibility in the warm start may translate into feasibility for the full formulation as long as unit constraints are not exceeded.

Next, the warm start up process may include determining initial level of stretching (e.g. −0% or 40% globally) for the pure network flow model. This step represents a starting point for the pure network flow model. Possible choices for a first cut may include having no stretching (favoring the objective function) or stretching at the maximum preferred rate (favoring feasibility). Then, the warm start may include for each OD pair: (a) select first service instance (demand arc) based on OD start time; (b) select successive service instances (demand arcs) by applying the relevant stretching level to the IGSI after the prior service; (c) set the lower and upper bounds of each selected demand arc equal to 1 (these arcs typically should be satisfied); (d) set the lower and upper bounds of unselected demand arcs equal to 0 (these arcs are essentially “zeroed out”); and (e) set the lower bound of bonus staging area idle arcs to the maximum number of buses requested for the bonus staging area. This step or process overcomes the difficulties of excessive arc quantity, timing interdependencies for penalties, and complicating side constraints. Specifying exactly which demand arcs are used to service OD pairs throughout the time horizon eliminates the need for the warm start to “decide” the best solution based upon guest satisfaction constraints. Timing between service instances is predetermined, resulting in a pure network flow model.

The warm start up process or algorithm steps performed by the computer or transportation system then may continue with solving the network model with the current bounds. This step may include solving the pure network flow model using the software tool(s). An advantage to a pure network flow model is that the solution to the relaxed linear problem is the solution to the integer problem as long as the arcs have an integer capacity (which is the case in many instances). The solver portion of the software tool(s) can be tuned via parameters to take advantage of faster algorithms to solve problems with a pure network structure. This is especially critical for a real-time dispatching application as the data gets stale very quickly. Applications typically may, for example, demand a 2 to 3 minute turnaround time from collecting data to sending dispatches to vehicles due to frequent changes in system dynamics.

Then, the warm start process may include comparing units used by the model to maximum units available by 15 minute interval. For each 15 minute interval, the warm start up process may include determining new stretching level. Such a determination may include if units used is determined to be greater than the maximum units available (solution is infeasible), then increasing stretching for that interval. Also, if units used are determined to be less than the maximum units available (solution is likely suboptimal), then decreasing stretching for that interval. These two steps serve the purposes of checking feasibility and gauging solution quality. A potential for infeasibility is the number of units in circulation at any given time. The software tool(s) may check this directly and make adjustments where needed. At the same time, opportunities to improve the objective function in the next iteration may be identified by reducing the amount of stretching in the network and decreasing the sum of the associated penalties.

The warm start up process may also include if changes are made to the model in the immediately prior step, then repeat steps involving each OD pair, solving the network model, comparing units used by the model to maximum units available, and determining new stretching levels. Otherwise warm-start is complete and may involve termination criteria such as the software tool(s) or its warm start algorithms/logic resolving to either execute an additional iteration or pass the problem onto the solver portion. The process may end with resetting all bounds to original values, adding constraints previously omitted, and running full formulation in the solver portion of the software tool(s) for improvement given the warm-start solution generated in the prior step. The warm start portion may be concluded and the solver portion engaged to search for a near-optimal solution. The bounds on the arcs may be reset at this point to their original values. The feasible solution found in the warm start may be fed to the solver, assuring a feasible solution and significantly narrowing the search space of potentially optimal solutions that may be generated, stored, and/or reported in step 860 of method 800 of FIG. 8.

After the dispatch assignments have been determined, the software tool(s) may act to determine labor assignments in a dynamic or real time basis. This may involve matching the assignments to buses and drivers. The labor assignments are determined in some cases through a relatively complicated logical heuristic that considers: (a) current location of each bus (e.g., as may be determined on an ongoing basis via GPS-based or other equipment); (b) a completion time that is determined or projected by the software tool(s) for a current route for each bus and for each driver; and (c) a determined next break or shift end for each driver. The assignments may be stored (such as shown at 162 in FIG. 1) and/or reported to drivers on an ongoing basis or periodically (such as every 15 minutes, every 30 minutes, every 60 minutes, every 90 minutes (as shown at 564 in FIG. 5), or the like).

The assignment determination tools or software (such as deployment tool 560 of FIG. 5) may employ vehicle business rules, driver business rules, and/or vehicle and driver business rules. For example, the determination tools or algorithms performed by a computer may include the following rules for determining labor assignments: (a) staging areas cannot exceed their capacity; (b) during certain times of the day, the algorithms attempts to schedule vehicles to idle at specific staging areas to be prepared for unexpected passenger demand; and (c) at the end of the night or operating period, each bus proceeds to the maintenance facility prior to shutting down at their home hub—subject to facility capacity.

Driver business rules related to drivers may include one or more of the following: (a) drivers are allowed travel time to and from their assigned bus; (b) drivers take their break within the time window specified by union or other similar rule/contract documents (e.g., breaks may have to take place at a home hub associated with each driver if is it open or at a specified alternate hub if heir home hub is closed); (c) drivers may be limited to only being assigned to routes for which they have been trained; (d) driver tasks may be assigned priorities, and the algorithm may schedule tasks to drivers in order of priority (e.g., all tasks of priority equal to or higher than driving should be scheduled); (e) if a driver is idle and no bus is available, the system may assign the driver to non-driving tasks; and (f) some drivers may be assigned specific tasks (e.g., meeting with a supervisor or the like) with a specific time that takes priority over any other task.

Some embodiments of the labor assignment determination tool (such as the deployment tool or the like) may apply and/or consider vehicle and driver business rules that are related to vehicles and drivers together in making the labor assignments. Such rules may require labor assignments that include non-driving tasks and/or effect timing of tasks or completion estimates and so on. These rules may include one or more of: (a) anytime a new driver takes over a bus, they must inspect the vehicle; (b) when a driver leaves their bus for either a break or end of shift, they can either shut their bus down in a staging area or get relieved by another driver after dropping off passengers in a load/drop off zone (sometimes called a driver swap and these driver swaps may lead to increased efficiency due to the length of time required to reach the shutdown areas from load/drop off zones that may take a bus off a demand arc); (c) since driver swaps require precise timing, the system “links” the two driver tasks together to make sure the swap is executed seamlessly, and linked tasks may be used anytime individual drivers are given tasks that depend on one another; and (d) routes that have multiple destinations may be called or considered “flexible routes,” and, in the case of flexible routes, the next route must be either a “completion route” that completes the drop offs only (and then the bus drives empty to its next location) or a demand-serving route that does pickups and drop offs simultaneously. “Linked” tasks are used whenever the system assigns two drivers and/or vehicles tasks that depend on one another, such as executing a driver swap in a load zone or sending a driver to a non-driving position.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of performing dynamic passenger-transport vehicle dispatching and dynamic labor assignments, comprising:
running a transportation services module with a processor on a computer system;
at the computer system, receiving current location information for a plurality of vehicles adapted for carrying passengers;
with the transportation services module, determining a route completion time period for each of the vehicles; and
with the transportation service module, generating a dispatch schedule for each of the vehicles based on the route completion time periods.

2. The method of claim 1, further comprising transmitting each of the dispatch schedules to the vehicles associated with the dispatch schedule for display on a monitor to a driver, whereby real time dispatching is provided to the drivers.

3. The method of claim 1, wherein the generating of the dispatch schedule further comprises determining demand for routes serviced by the vehicles based on counts of the passengers, wherein the dispatch schedule is modified based on the determined demand.

4. The method of claim 3, wherein the generating of the dispatch schedule further comprises determining service intervals for the routes serviced by the vehicles based on the received current location information, wherein the dispatch schedule is modified based on the determined service intervals and a set of predefined goal service intervals for the routes.

5. The method of claim 4, wherein the demand and service intervals are determined for a plurality of origin and destination pairs on the routes.

6. The method of claim 4, wherein the generating of the dispatch schedule further comprises assigning penalties to a set of the vehicles based on a comparison of the determined service intervals and the goal service intervals for the routes.

7. The method of claim 1, further comprising determining and reporting a set of labor assignments for drivers of the vehicles based on the current location information, the route completion time periods, and break and shift information associated with each of the drivers.

8. The method of claim 1, wherein the generating of the dispatch schedule comprises constructing a network flow model for a geographic service area for the vehicles and solving the network flow model to provide demand and service information for use by the transportation services module in creating the dispatch schedule for the vehicles on routes serviced by the vehicles.

9. A transportation system, comprising:
a plurality of buses;
an automatic passenger counter positioned on each of the buses;
a vehicle location mechanism positioned on each of the buses; and
a deployment system in wireless communication with the buses receiving count data from the buses from the automatic passenger counters and location information from the vehicle location mechanisms, wherein the deployment system inputs the count data and the location information into a network flow model in memory and, based on the network flow model generates and transmits dispatch schedule information for the buses.

10. The system of claim 9, wherein the count data is attributed to a plurality of origin-destination pairs associated with a plurality of routes services by the buses to determine demand for the buses including determining ridership for each of the buses for at least one of the OD pairs.

11. The system of claim 9, wherein the deployment system determines a next break or shift end for each of driver of the buses and based on the determined next break or shift ends for the drivers and on the location information, generates a set of labor assignments for the drivers including assignments of at least a portion of the drivers to the buses.

12. The system of claim 11, wherein the deployment system further determines a projected completion time of current routes for the buses based on the location information and wherein the generating of the set of labor assignments is performed based on the projected completion times.

13. The system of claim 9, wherein the deployment system further comprises a network flow model stored in the memory modeling routes within a geographic area services by the buses of the transportation system, wherein each of the routes comprises one or more origin-destination pairs, and wherein the network flow model is solved by the deployments system using the count data and the location information to determine demand for origin-destination pairs.

14. The system of claim 13, wherein the deployment system further determines service intervals for the origin-destination pairs and wherein the dispatch schedule information is generated based on a comparison of the determined service intervals and determined demand with transportation service levels stored in the memory.

15. A computer-based method for dynamically dispatching passenger-carrying vehicles and drivers for the vehicles on routes of a transportation system, comprising:
providing a dispatching system with a processor running a dispatch and driver assignment tool and with data storage storing a network flow model modeling the routes of the transportation system;
operating the dispatching system to receive location information from a plurality of the vehicles traveling the routes;
with the dispatch and driver assignment tool, solving the network flow model using the received location information; and
with the dispatch and driver assignment tool, generating a dispatch schedule for the vehicles based on the solved network flow model.

16. The method of claim 15, further comprising operating the dispatch and driver assignment tool to determine current locations of the vehicles within the transportation system, projecting completion times of the routes by the vehicles based on the determined current locations, and generating a labor assignment for the drivers based on the projected completion times and based on break or shift end times associated with each of the drivers.

17. The method of claim 15, further comprising receiving passenger count information from the vehicles and determining with the dispatch and driver assignment tool demand for the routes, wherein the solving the network flow model comprises using the determined demand.

18. The method of claim 15, wherein the routes each comprise a set of origin-destination pairs and the generating of the dispatch schedule comprises determining service intervals for each of the origin-destination pairs, comparing the determined service intervals with predefined goal service intervals stored in the data storage, and modifying the dispatch schedule when one or more of the determined service intervals is greater than one or more of the predefined goal service intervals.

19. The method of claim 15, wherein the operating of the dispatching system to receive the location information, the solving of the network flow model, and the generating dispatch schedule are performed at least every 2 hours during an operating period for the transportation system.

20. The method of claim 19, wherein the location information comprises global positioning satellite (GPS) information and is received at least every 15 minutes.
